(19) United States
(12) Patent Application Publication
(10) Pub. No.: US 2013/0325774 A1
(43) Pub. Date: Dec. 5, 2013

(54) LEARNING STOCHASTIC APPARATUS AND METHODS

(71) Applicants: Oleg Sinyavskiy, San Diego, CA (US); Olivier Coenen, San Diego, CA (US)

(72) Inventors: Oleg Sinyavskiy, San Diego, CA (US); Olivier Coenen, San Diego, CA (US)

(73) Assignee: Brain Corporation, San Diego, CA (US)

(21) Appl. No.: 13/487,621

(22) Filed: Jun. 4, 2012

(51) Int. Cl. G06F 15/18

(52) U.S. Cl. 706/23

(57) ABSTRACT

Generalized learning rules may be implemented. A framework may be used to enable adaptive signal processing system to flexibly combine different learning rules (supervised, unsupervised, reinforcement learning) with different methods (online or batch learning). The generalized learning framework may employ non-associative transform of time-averaged performance function as the learning measure, thereby enabling modular architecture where learning tasks are separated from control tasks, so that changes in one of the modules do not necessitate changes within the other. The use of non-associative transformations, when employed in conjunction with gradient optimization methods, does not bias the performance function gradient, on a long-term averaging scale and may advantageously enable stochastic drift thereby facilitating exploration leading to faster convergence of learning process. When applied to spiking learning networks, transforming the performance function using a constant term, may lead to non-associative increase of synaptic connection efficacy thereby providing additional exploration mechanisms.

### CROSS-REFERENCE TO RELATED APPLICATIONS

This application is related to a co-owned and co-pending U.S. patent application Ser. No. 13/______ entitled “STOCHASTIC APPARATUS AND METHODS FOR IMPLEMENTING GENERALIZED LEARNING RULES” [attorney docket 021672-0405921, client reference BC201202A], filed contemporaneously herewith, co-owned U.S. patent application Ser. No. 13/______ entitled “STOCHASTIC SPIKING NETWORK LEARNING APPARATUS AND METHODS”, [attorney docket 021672-0407107, client reference BC201203A], filed contemporaneously herewith, and co-owned U.S. patent application Ser. No. 13/______ entitled “DYNAMICALLY RECONFIGURABLE STOCHASTIC LEARNING APPARATUS AND METHODS”, [attorney docket 021672-0407729, client reference BC201211A], filed contemporaneously herewith, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Disclosure

The present disclosure relates to implementing generalized learning rules in stochastic systems.

2. Description of Related Art

Adaptive signal processing systems are well known in the arts of computerized control and information processing. One typical configuration of an adaptive system of prior art is shown in FIG. 1. The system 100 may be capable of changing or “learning” its internal parameters based on the input 102, output 104 signals, and/or an external influence 106. The system 100 may be commonly described using a function 110 that depends (including probabilistic dependence) on the history of inputs and outputs of the system and/or on some external signal r that is related to the inputs and outputs. The function F(x,y,r) may be referred to as a “performance function”. The purpose of adaptation (or learning) may be to optimize the input-output transformation according to some criteria, where learning is described as minimization of an average value of the performance function F.

Although there are numerous models of adaptive systems, these typically implement a specific set of learning rules (e.g., supervised, unsupervised, reinforcement). Supervised learning may be the machine learning task of inferring a function from supervised (labeled) training data. Reinforcement learning may refer to an area of machine learning concerned with how an agent ought to take actions in an environment so as to maximize some notion of reward (e.g., immediate or cumulative). Unsupervised learning may refer to the problem of trying to find hidden structure in unlabeled data. Because the examples given to the learner are unlabeled, there is no external signal to evaluate a potential solution.

When the task changes, the learning rules (typically effected by adjusting the control parameters w={w₁, w₂, . . . , wₙ}) may need to be modified to suit the new task. Hereinafter, the boldface variables and symbols with arrow superscripts denote vector quantities, unless specified otherwise. Complex control applications, such as for example, autonomous robot navigation, robotic object manipulation, and/or other applications may require simultaneous implementation of a broad range of learning tasks. Such tasks may include visual recognition of surroundings, motion control, object (face) recognition, object manipulation, and/or other tasks. In order to handle these tasks simultaneously, existing implementations may rely on a partitioning approach, where individual tasks are implemented using separate controllers, each implementing its own learning rule (e.g., supervised, unsupervised, reinforcement).

One conventional implementation of a multi-task learning controller is illustrated in FIG. 1A. The apparatus 120 comprises several blocks 120, 124, 130, each implementing a set of learning rules tailored for the particular task (e.g., motor control, visual recognition, object classification and manipulation, respectively). Some of the blocks (e.g., the signal processing block 130 in FIG. 1A) may further comprise sub-blocks (e.g., the blocks 132, 134) targeted at different learning tasks. Implementation of the apparatus 120 may have several shortcomings stemming from each block having a task specific implementation of learning rules. By way of example, a recognition task may be implemented using supervised learning while object manipulator tasks may comprise reinforcement learning. Furthermore, a single task may require use of more than one rule (e.g., signal processing task for block 130 in FIG. 1A) thereby necessitating use of two separate sub-blocks (e.g., blocks 132, 134) each implementing different learning rule (e.g., unsupervised learning and supervised learning, respectively).

Artificial neural networks may be used to solve some of the described problems. An artificial neural network (ANN) may include a mathematical and/or computational model inspired by the structure and/or functional aspects of biological neural networks. A neural network comprises a group of artificial neurons (units) that are interconnected by synaptic connections. Typically, an ANN is an adaptive system that is configured to change its structure (e.g., the connection configuration and/or neuronal states) based on external or internal information that flows through the network during the learning phase.

A spiking neuronal network (SNN) may be a special class of ANN, where neurons communicate by sequences of spikes. SNN may offer improved performance over conventional technologies in areas which include machine vision, pattern detection and pattern recognition, signal filtering, data segmentation, data compression, data mining, system identification and control, optimization and scheduling, and/or complex mapping. Spike generation mechanism may be a discontinuous process (e.g., as illustrated by the pre-synaptic spikes sx(t) 220, 222, 224, 226, 228, and post-synaptic spike train sy(t) 230, 232, 234 in FIG. 2) and a classical derivative of function F(s(t)) with respect to spike trains sx(t), sy(t) is not defined.

Even when a neural network is used as the computational engine for these learning tasks, individual tasks may be performed by a separate network partition that implements a task-specific set of learning rules (e.g., adaptive control, classification, recognition, prediction rules, and/or other rules). Unused portions of individual partitions (e.g., motor control when the robotic device is stationary) may remain unavailable to other partitions of the network that may require increased processing resources (e.g., when the stationary robot is performing face recognition tasks). Furthermore, when the learning tasks change during system operation, such partitioning may prevent dynamic retargeting (e.g., of the motor control task to visual recognition task) of the network partitions. Such solutions may lead to expensive and/or over-designed networks, in particular when individual portions are designed using the “worst possible case scenario” approach. Similarly, partitions designed using a limited resource pool configured to handle an average task load may be unable to handle infrequently occurring high computational loads that are beyond a performance capability of the particular partition, even when other portions of the networks have spare capacity.

By way of illustration, consider a mobile robot controlled by a neural network, where the task of the robot is to move in an unknown environment and collect certain resources by the way of trial and error. This can be formulated as reinforcement learning tasks, where the network is supposed to maximize the reward signals (e.g., amount of the collected resource). While in general the environment is unknown, there may be possible situations when the human operator can show to the network desired control signal (e.g., for avoiding obstacles) during the ongoing reinforcement learning. This may be formulated as a supervised learning task. Some existing learning rules for the supervised learning may rely on the gradient of the performance function. The gradient for reinforcement learning part may be implemented through the use of the adaptive critic; the gradient for supervised learning may be implemented by taking a difference between the supervisor signal and the actual output of the controller. Introduction of the critic may be unnecessary for solving reinforcement learning tasks, because direct gradient-based reinforcement learning may be used instead. Additional analytic derivation of the learning rules may be needed when the loss function between supervised and actual output signal is redefined.

While different types of learning may be formalized as a minimization of the performance function F, an optimal minimization solution often cannot be found analytically, particularly when relationships between the system's behavior and the performance function are complex. By way of example, nonlinear regression applications generally may not have analytical solutions. Likewise, in motor control applications, it may not be feasible to analytically determine the reward arising from external environment of the robot, as the reward typically may be dependent on the current motor control command and state of the environment.

Moreover, analytic determination of a performance function F derivative may require additional operations (often performed manually) for individual new formulated tasks that are not suitable for dynamic switching and reconfiguration of the tasks described before.

Some of the existing approaches of taking a derivative of a performance function without analytic calculations may include a “brute force” finite difference estimator of the gradient. However, these estimators may be impractical for use with large spiking networks comprising many (typically in excess of hundreds) parameters.

Derivative-free methods, specifically Score Function (SF), also known as Likelihood Ratio (LR) method, exist. In order to determine a direction of the steepest descent, these methods may sample the value of F(x,y) in different points of parameter space according to some probability distribution. Instead of calculating the derivative of the performance function F(x,y), the SR and LR methods utilize a derivative of the sampling probability distribution. This process can be considered as an exploration of the parameter space.

Although some adaptive controller implementations may describe reward-modulated unsupervised learning algorithms, these implementations of unsupervised learning algorithms may be multiplicatively modulated by reinforcement learning signal and, therefore, may require the presence of reinforcement signal for proper operation.

Many presently available implementations of stochastic adaptive apparatuses may be incapable of learning to perform unsupervised tasks while being influenced by additive reinforcement (and vice versa). Many presently available adaptive implementations may be task-specific and implement one particular learning rule (e.g., classifier unsupervised learning), and such devices invariably require retargeting (e.g., reprogramming) in order to implement different learning rules. Furthermore, presently available methodologies may not be capable of implementing generalized learning, where a combination of different learning rules (e.g., reinforcement, supervised and supervised) are used simultaneously for the same application (e.g., platform motion stabilization), thereby enabling, for example, faster learning convergence, better response to sudden changes, and/or improved overall stability, particularly in the presence or noise.

### Stochastic Spiking Neuron Models

Where certain elements of these implementations can be partially or fully implemented using known components, only those portions of such known components that are necessary for an understanding of the present disclosure will be described, and detailed descriptions of other portions of such known components will be omitted so as not to obscure the disclosure.

Learning rules used with spiking neuron networks may be typically expressed in terms of original spike trains instead of their secondary features (e.g., the rate or the latency from the last spike). The result is that a spiking neuron operates on spike train space, transforming a vector of spike trains (input spike trains) into single element of that space (output train). Dealing with spike trains directly may be a challenging task. Not every spike train can be transformed to another spike train in a continuous manner. One common approach is to describe the task in terms of optimization of some function and then use gradient approaches in the parameter space of the spiking neuron. However gradient methods on discontinuous spaces such as spike trains space are not well developed. One approach may involve smoothing the spike trains first. Here output spike trains are smoothed with introduction of probabilistic measure on a spike trains space. Describing the spike pattern from a probabilistic point of view may lead to fruitful connections with the huge amount of topics within information theory, machine learning, Bayesian inference, statistical data analysis etc. This approach makes spiking neurons a good candidate to use SF/LR learning methods.

One technique frequently used when constructing learning rules in a spiking network, comprises application of a random exploration process to a spike generation mechanism of a spiking neuron. This is often implemented by introducing a noisy threshold: probability of a spike generation may depend on the difference between neuron's membrane voltage and a threshold value. The usage of probabilistic spiking neuron models, in order to obtain gradient of the log-likelihood of a spike train with respect to neuron's weights, may comprise an extension of Hebbian learning framework to spiking neurons. The use of the log-likelihood gradient of a spike train may be extended to supervised learning. In some approaches, information theory framework may be applied to spiking neurons, as for example, when deriving optimal learning rules for unsupervised learning tasks via informational entropy minimization.

An application of the OLPOMDM algorithm to the solution of the reinforcement learning problems with simplified spiking neurons has been done. Extending of this algorithm to more plausible neuron model has been done. However no generalizations of the OLPOMDM algorithm have been done in order to use it unsupervised and supervised learning in spiking neurons. An application of reinforcement learning ideas to supervised learning has been described, however only heuristic algorithms without convergence guarantees have been used.

For a neuron, the probability of an output spike train, y, to have spikes at times t_f with no spikes at the other times on a time interval [0, T], given the input spikes, x, may be given by the conditional probability density function p(y|x) as:

p(y|x)=Πₜ_{_{f}}λ(t_{f})e^{-∫}^{₀}^{^{T}}^{λ(τ)dτ} (Eqn. 1)

where λ(t) represents an instantaneous probability density (“hazard”) of firing.

The instantaneous probability density of the neuron can depend on a neuron's state q(t): λ(t)≡λ(q(t)). For example, it can be defined according to its membrane voltage u(t) for continuous time chosen as an exponential stochastic threshold:

λ(t)=λₒe^{κ(u(t)-θ)} (Eqn. 2)

where u(t) is the membrane voltage of the neuron, θ is the voltage threshold for generating a spike, K is the probabilistic parameter, and λ₀ is the basic (spontaneous) firing rate of the neuron.

Some approaches utilize sigmoidal stochastic threshold, expressed as:

$$λ ( t ) = \frac{{λ}_{0}}{1 - {e}^{- κ ( u ( t ) - θ )}} \qquad ( Eqn . 3 )$$

or an exponential-linear stochastic threshold:

λ(t)=λ₀ ln(1+e^{κ(u(t)-θ)} (Eqn. 4)

where λ₀, κ, θ are parameters with a similar meaning to the parameters in the exponential threshold model Eqn. 2.

Models of the stochastic threshold exist comprising refractory mechanism that modulate the instantaneous probability of firing after the last output spike λ(t)=\hat{λ}(t)R(t, tₗₐₛₜ^{out}), where \hat{λ}(t) is the original stochastic threshold function (such as exponential or other) and R(tₗₐₛₜ^{out}-t) is the dynamic refractory coefficient that depends on the time since the last output spike tₗₐₛₜ^{out}.

For discrete time steps, an approximation for the probability Λ(u(t))ε(0,1] of firing in the current time step may be given by:

Λ(u(t))=1−e^{-λ(u(t))Δt} (Eqn. 5)

where Δt is the time step length.

In one dimensional deterministic spiking models, such as Integrate-and-Fire (IF), Quadratic Integrate-and-Fire (QIF) and others, membrane voltage u(t) is the only one state variable (q(t)≡u(t)) that is “responsible” for spike generation through deterministic threshold mechanism. There also exist plenty of more complex multidimensional spiking models. For example, a simple spiking model may comprise two state variables where only one of them is compared with a threshold value. However, even detailed neuron models may be parameterized using a single variable (e.g., an equivalent of “membrane voltage” of biological neuron) and use it with a suitable threshold in order to determine the presence of spike. Such models are often extended to describe stochastic neurons by replacing deterministic threshold with a stochastic threshold.

Generalized dynamics equations for spiking neurons models are often expressed as a superposition of input, interaction between the input current and the neuronal state variables, and neuron reset after the spike as follows:

$$\frac{d \vec{q}}{d t} = V ( \vec{q} ) + {\sum }_{{t}^{out}}^{ } R ( \vec{q} ) δ ( t - {t}^{out} ) + G ( \vec{q} ) {I}^{ext} \qquad ( Eqn . 6 )$$

where: [symbol] is a vector of internal state variables (e.g., comprising membrane voltage); I^{ext} is external input to the neuron; V is the function that defines evolution of the state variables; G describes the interaction between the input current and the state variables (for example, to model synaptic depletion); and R describes resetting the state variables after the output spikes at t^{out}.

For example, for IF model the state vector and the state model may be expressed as:

\vec{q}≡u(t);V(\vec{q})=−Cu;R(\vec{q})=uᵣₑₛ−u;G(\vec{q})=1, (Eqn. 7)

where C is a membrane constant, uᵣₑₛ is a value to which voltage is set after output spike (reset value). Accordingly, Eqn. 6 becomes:

$$\frac{d u}{d t} = - Cu + {\sum }_{{t}^{out}}^{ } ( {u}_{refr} - u ) δ ( t - {t}^{out} ) + {I}^{ext} \qquad ( Eqn . 8 )$$

For some simple neuron models, Eqn. 6 may be expressed as:

$$\begin{matrix}\frac{d v}{d t} = 0.04 {v}^{2} + 5 v + 140 - u + {\sum }_{{t}^{out}}^{ } ( c - v ) δ ( t - {t}^{out} ) + {I}^{ext} \\ \frac{d u}{d t} = a ( bv - u ) + d {\sum }_{{t}^{out}}^{ } δ ( t - {t}^{out} ) , & ( Eqn . 9 ) \\ where : \\ \begin{matrix}{ q}^{ •} ( t ) ≡ ( \begin{matrix}v ( t ) \\ u ( t )\end{matrix} ) ; \\ V ( {q}^{•} ) = ( \begin{matrix}0.04 {v}^{2} ( t ) + 5 v ( t ) + 140 - u ( t ) \\ a ( bv ( t ) - u ( t ) )\end{matrix} ) ; \\ R ( {q}^{•} ) = ( \begin{matrix}c - v ( t ) \\ d\end{matrix} ) ; \\ G ( {q}^{•} ) = ( \begin{matrix}1 \\ 0\end{matrix} )\end{matrix} & ( Eqn . 10 )\end{matrix}$$

and a, b, c, d are parameters of the model.

Many presently available implementations of stochastic adaptive apparatuses may be incapable of learning to perform unsupervised tasks while being influenced by additive reinforcement (and vice versa). Furthermore, presently available methodologies may not provide for rapid convergence during learning, particularly when generalized learning rules, such as, for example comprising a combination of reinforcement, supervised and supervised learning rules, are used simultaneously and/or in the presence of noise.

Accordingly, there is a salient need for machine learning apparatus and methods to implement improved learning in stochastic systems configured to handle any learning rule combination (e.g., reinforcement, supervised, unsupervised, online, batch) and is capable of, inter alia, dynamic reconfiguration using the same set of network resources while providing for rapid convergence during learning.

### SUMMARY

The present disclosure satisfies the foregoing needs by providing, inter alia, apparatus and methods for implementing generalized probabilistic learning configured to handle simultaneously various learning rule combinations.

One aspect of the disclosure relates to one or more computerized apparatus, and/or computer-implemented methods for effectuating a spiking network stochastic signal processing system configured to implement task-specific learning. In one implementation, the apparatus may comprise a storage medium comprising a plurality of instructions configured to, when executed, accelerate convergence of a task-specific stochastic learning process towards a target response by at least at time determine response of the process to (i) input signal, the response having a present performance associated therewith, the performance configured based at least in part on the response, the input signal and a deterministic control parameter; determine a time-averaged performance based at least in part on a plurality of past performance values, each of the past performance values having been determined over a time interval prior to the time; and adjust the control parameter based at least in part on a combination of the present performance and the time-averaged performance, and the combination is configured to effectuate the accelerate convergence characterized by a shorter convergence time compared to parameter adjustment configured based solely on the present performance.

In some implementations, the adjustment of the control parameter may be configured to transition the response to another response, the transition having a performance measure associated therewith; the response having state of the process associated therewith; the another response having another state of the process associated therewith; the target response may be characterized by a target state of the process; and a value of the measure, comprising a difference between the target state and the another state may be smaller compared to another value of the measure, comprising a difference between the target state and the state; and the combination may comprise a difference between the present performance and the time-averaged performance.

In some implementations, the response may be configured to be updated at a response interval; the time averaged performance may be determined with respect to a time interval, the time interval being greater that the response interval.

In some implementations, a ratio of the time interval to the response interval may be in the range between 2 and 10000.

In some implementations, the control parameter may be configured in accordance with the task; and the adjustment the control parameter may be configured based at least in part on the input signal and the response.

In another aspect a method of implementing task learning in a computerized stochastic spiking neuron apparatus, may comprise: operating the apparatus in accordance with a stochastic learning process characterized by a deterministic learning parameter, the process configured, based at least in part, on an input signal and the task; configuring performance metric based at least in part on (i) a response of the process to the signal and the learning parameter, and (ii) the input; applying a monotonic transformation to the performance metric, the monotonic transformation configured to produce transformed performance metric; determining an adjustment of the learning parameter based at least in part on an average of the transformed performance metric, and applying the adjustment to the stochastic learning process, the applying may be configured to reduce time required to achieve desired response by the apparatus to the signal; and wherein the transformation may be configured to accelerate the task learning.

In some implementations, the process may be characterized by (i) a present state having present value of the learning parameter and a present value of the performance metric associated therewith; and target state having target value of the learning parameter and a target value of the performance metric associated therewith; and the learning may comprise minimizing the performance metric such that the target value of the performance metric may be less than the present value of the performance metric.

In some implementations, the minimizing the performance metric may comprise transitioning the present state towards the target state, the transitioning effectuated by at least the applying the adjustment to the stochastic learning process; and accelerate of the learning may be characterized by a convergence time interval that may be smaller when compared to parameter adjustment configured based solely on the performance metric.

In some implementations, the stochastic learning process may be characterized by a residual error of the performance metric; and the application of the transformation may be configured to reduce the residual error compared to another residual error associated with the process being operated prior to the applying the transformation.

In some implementations the process may comprise: minimization of the performance metric with respect to the learning parameter; the monotonic transformation may comprise an additive transformation comprising a transform parameter; and the transformed performance metric may be free from systematic deviation.

In some implementations the transform parameter may comprise a constant configured to enable changes in parameters that are not associated with value of the performance function.

In some implementations, the process may comprise: minimization of the performance metric with respect to the learning parameter; the monotonic transformation may comprise an exponential transformation comprising an exponent parameter and an offset parameter; and the transformed performance metric may be free from systematic deviation.

In some implementations, a computerized spiking network apparatus may comprise one or more processors configured to execute one or more computer program modules, wherein execution of individual ones of the one or more computer program modules may cause the one or more processors to reduce convergence time of a process effectuated by the network by at least: operate the process according to a hybrid learning rule configured to generate an output signal based on an input spike train and a teaching signal; transform a performance measure associated with the process to obtain a transformed performance measure; generate an adjustment signal based at least in part on the transformed performance; and wherein applying the adjustment signal to the process may be configured to achieve the desired output in a shorter period of time compared to applying one other adjustment signal, generate based at least in part on the performance.

In some implementations, the hybrid learning rule comprising a combination of reinforcement, supervised and unsupervised learning rules effectuated simultaneous with one another.

In some implementations, the hybrid learning rule may be configured to simultaneously effect reinforcement learning rule and supervised learning rule.

In some implementations, the teaching signal r may comprise a reinforcement spike train determined based at least in part on a comparison between present output, associated with the transformed performance, and the output signal; and the transformed performance measure may be configured to effect a reinforcement learning rule, based at least in part on the reinforcement spike train.

In some implementations, applying the adjustment signal to the process may comprise modifying a control parameter associated with the process; the transformed performance may be based at least in part on adjustment of the control parameter from a prior state to present state; the reinforcement may be positive when the present output may be closer to the output signal, and the reinforcement may be negative when the present output may be farther from the output signal.

In some implementations, the adjustment signal may be configured to modify a learning parameter, associated with the process; the adjustment signal may be determined based at least in part on a product of the transformed performance with a gradient of per-stimulus entropy parameter h, the gradient may be determined with respect to the learning parameter; and the per-stimulus entropy parameter may be configured to characterize dependence of the signal on (i) the input signal; and (ii) the learning parameter.

In some implementations, the per-stimulus entropy parameter may be determined based on a natural logarithm of p(y|x,w), where p denotes conditional probability of the output signal y given the input signal x with respect to the learning parameter w.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

FIG. 1 is a block diagram illustrating a typical architecture of an adaptive system according to prior art.

FIG. 1A is a block diagram illustrating multi-task learning controller apparatus according to prior art.

FIG. 2 is a graphical illustration of typical input and output spike trains according to prior art.

FIG. 3 is a block diagram illustrating generalized learning apparatus, in accordance with one or more implementations.

FIG. 4 is a block diagram illustrating learning block apparatus of FIG. 3, in accordance with one or more implementations.

FIG. 4A is a block diagram illustrating exemplary implementations of performance determination block of the learning block apparatus of FIG. 4, in accordance with the disclosure.

FIG. 5 is a block diagram illustrating generalized learning apparatus, in accordance with one or more implementations.

FIG. 5A is a block diagram illustrating generalized learning block configured for implementing different learning rules, in accordance with one or more implementations.

FIG. 6 is a block diagram illustrating generalized learning block configured for implementing different learning rules, in accordance with one or more implementations.

FIG. 7 is a block diagram illustrating spiking neural network configured to effectuate multiple learning rules, in accordance with one or more implementations.

FIG. 8A is a logical flow diagram illustrating generalized learning method comprising performance transformation for use with the apparatus of FIG. 5A, in accordance with one or more implementations.

FIG. 8B is a logical flow diagram illustrating learning method comprising performance transformation comprising base line performance removal for use with the apparatus of FIG. 5A, in accordance with one or more implementations.

FIG. 8C is a logical flow diagram illustrating several exemplary implementations of base line removal for use with the performance transformation method of FIG. 8B, in accordance with one or more implementations.

FIG. 9A is a plot presenting simulations data illustrating operation of the neural network of FIG. 7 prior to learning, in accordance with one or more implementations, where data in the panels from top to bottom comprise: (i) input spike pattern; (ii) output activity of the network before learning; (iii) supervisor spike pattern; (iv) positive reinforcement spike pattern; and (v) negative reinforcement spike pattern.

FIG. 9B is a plot presenting simulations data illustrating supervised learning operation of the neural network of FIG. 7, in accordance with one or more implementations, where data in the panels from top to bottom comprise: (i) input spike pattern; (ii) output activity of the network before learning; (iii) supervisor spike pattern; (iv) positive reinforcement spike pattern; and (v) negative reinforcement spike pattern.

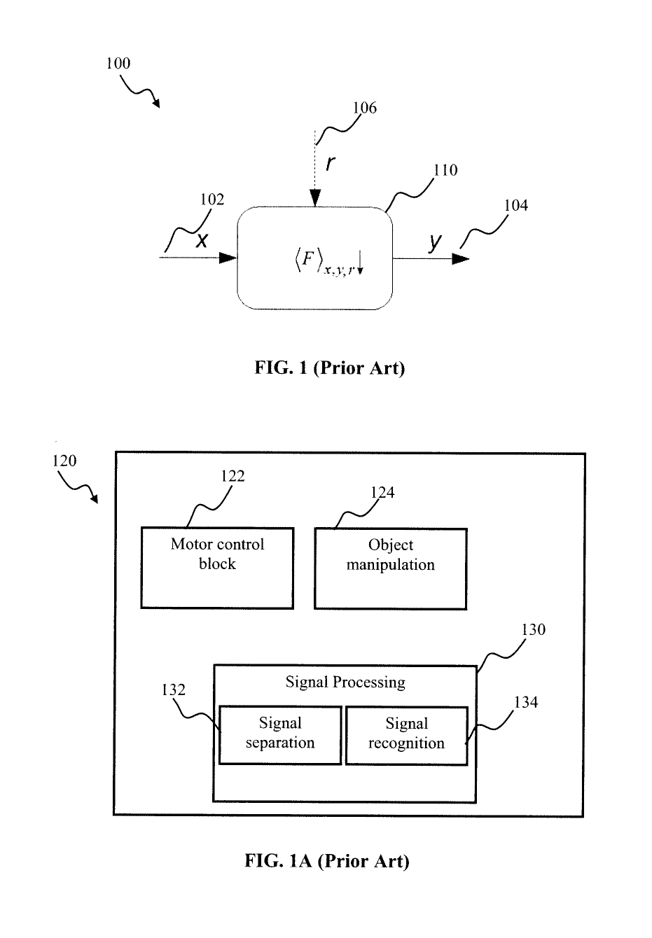

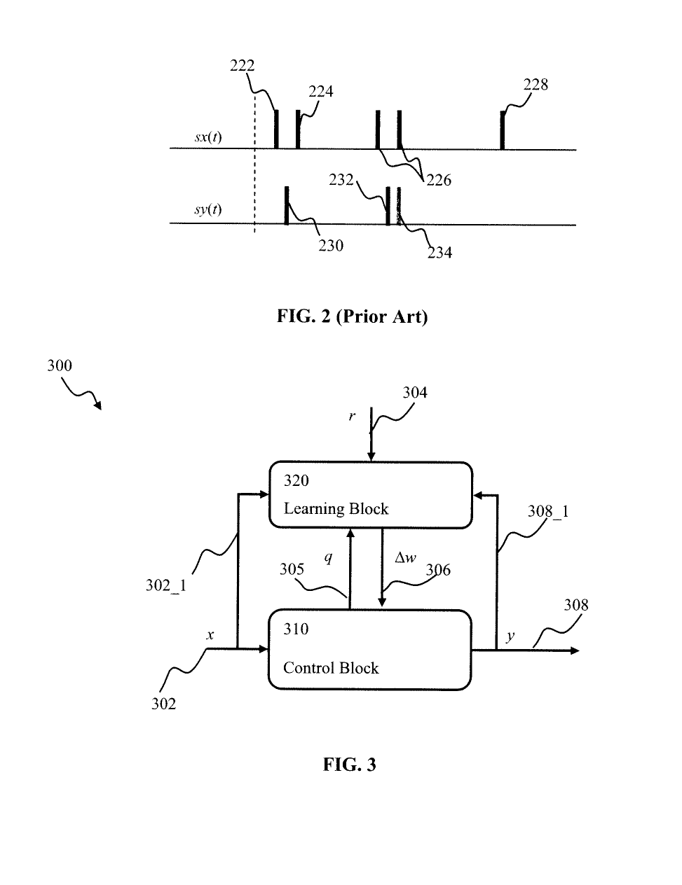

All Figures disclosed herein are ® Copyright 2012 Brain Corporation. All rights reserved.

### DETAILED DESCRIPTION

Exemplary implementations of the present disclosure will now be described in detail with reference to the drawings, which are provided as illustrative examples so as to enable those skilled in the art to practice the disclosure. Notably, the figures and examples below are not meant to limit the scope of the present disclosure to a single implementation, but other implementations are possible by way of interchange of or combination with some or all of the described or illustrated elements. Wherever convenient, the same reference numbers will be used throughout the drawings to refer to same or similar parts.

Where certain elements of these implementations can be partially or fully implemented using known components, only those portions of such known components that are necessary for an understanding of the present disclosure will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “bus” is meant generally to denote all types of interconnection or communication architecture that is used to access the synaptic and neuron memory. The “bus” may be optical, wireless, infrared, and/or another type of communication medium. The exact topology of the bus could be for example standard “bus”, hierarchical bus, network-on-chip, address-event-representation (AER) connection, and/or other type of communication topology used for accessing, e.g., different memories in pulse-based system.

As used herein, the terms “computer”, “computing device”, and “computerized device “may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB™, PASCAL, Python, assembly language, markup languages (e.g., HTML, SGML, XML, VoXML), object-oriented environments (e.g., Common Object Request Broker Architecture (CORBA)), Java™ (e.g., J2ME, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), application-specific integrated circuits (ASICs), and/or other types of integrated circuits.

As used herein, the terms “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, and/or software interface with a component, network, and/or process. By way of non-limiting example, a network interface may include one or more of FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., 3G, LTE/LTE-A/TD-LTE, GSM, etc.), IrDA families, and/or other network interfaces.

As used herein, the terms “node”, “neuron”, and “neuronal node” are meant to refer, without limitation, to a network unit (e.g., a spiking neuron and a set of synapses configured to provide input signals to the neuron) having parameters that are subject to adaptation in accordance with a model.

As used herein, the terms “state” and “node state” is meant generally to denote a full (or partial) set of dynamic variables used to describe node state.

As used herein, the term “synaptic channel”, “connection”, “link”, “transmission channel”, “delay line”, and “communications channel” include a link between any two or more entities (whether physical (wired or wireless), or logical/virtual) which enables information exchange between the entities, and may be characterized by a one or more variables affecting the information exchange.

As used herein, the term “Wi-Fi” includes one or more of IEEE-Std. 802.11, variants of IEEE-Std. 802.11, standards related to IEEE-Std. 802.11 (e.g., 802.11a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, LTE/LTE-A/TD-LTE, analog cellular, CDPD, satellite systems, millimeter wave or microwave systems, acoustic, infrared (i.e., IrDA), and/or other wireless interfaces.

### Overview

The present disclosure provides, among other things, improved computerized apparatus and methods for obtaining faster convergence when using stochastic learning rules. In one implementation of the disclosure, adaptive stochastic signal processing apparatus may employ a learning rule comprising non-associative transformation of the cost function, associated with the rule. In some implementations, the cost function may comprise a time-average performance function and the transformation may comprise an addition (or a subtraction) of a constant term. When utilized in conjunction with gradient optimization methods, constant term addition may not bias the performance function gradient, on a long-term averaging scale, and may shift the gradient on short term time scale. Such shift may advantageously enable stochastic drift thereby facilitating exploration leading to faster convergence of learning process. When applied to spiking learning networks, transforming the performance function using a constant term, may lead to non-associative increase (and/or decrease) of synaptic connection efficacy thereby providing additional exploration mechanisms.

In one or more implementations, the transformation may comprise addition (or subtraction) of a baseline performance function. The baseline performance may be configured using interval average or running average, according to one or more implementations.

In some implementations, the performance function transformation may comprise any monotonous transform that does not change the location of the performance function local extremum. Performance function configurations comprising such monotonous transformations may advantageously provide for faster convergence and better accuracy of learning.

The generalized learning framework described herein advantageously provides for learning implementations that do not affect regular operation of the signal system (e.g., processing of data). Hence, a need for a separate learning stage may be obviated so that learning may be turned off and on again when appropriate.

One or more generalized learning methodologies described herein may enable different parts of the same network to implement different adaptive tasks. The end user of the adaptive device may be enabled to partition network into different parts, connect these parts appropriately, and assign cost functions to each task (e.g., selecting them from predefined set of rules or implementing a custom rule). A user may not be required to understand detailed implementation of the adaptive system (e.g., plasticity rules, neuronal dynamics, etc.) nor may he be required to be able to derive the performance function and determine its gradient for each learning task. Instead, the users are able to operate generalized learning apparatus of the disclosure by assigning task functions and connectivity map to each partition.

### Generalized Learning Apparatus

Detailed descriptions of various implementations of apparatuses and methods of the disclosure are now provided. Although certain aspects of the disclosure may be understood in the context of robotic adaptive control system comprising, for example a spiking neural network, the disclosure is not so limited. Implementations of the disclosure may also be used for implementing a variety of stochastic adaptive systems, such as, for example, signal prediction (e.g., supervised learning), finance applications, data clustering (e.g., unsupervised learning), inventory control, data mining, and/or other applications that do not require performance function derivative computations.

Implementations of the disclosure may be, for example, deployed in a hardware and/or software implementation of a neuromorphic computer system. In some implementations, a robotic system may include a processor embodied in an application specific integrated circuit, which can be adapted or configured for use in an embedded application (e.g., a prosthetic device).

FIG. 3 illustrates one exemplary learning apparatus useful to the disclosure. The apparatus 300 shown in FIG. 3 comprises the control block 310, which may include a spiking neural network configured to control a robotic arm and may be parameterized by the weights of connections between artificial neurons, and learning block 320, which may implement learning and/or calculating the changes in the connection weights. The control block 310 may receive an input signal x, and may generate an output signal y. The output signal y may include motor control commands configured to move a robotic arm along a desired trajectory. The control block 310 may be characterized by a system model comprising system internal state variables S. An internal state variable S may include a membrane voltage of the neuron, conductance of the membrane, and/or other variables. The control block 310 may be characterized by learning parameters w, which may include synaptic weights of the connections, firing threshold, resting potential of the neuron, and/or other parameters. In one or more implementations, the parameters w may comprise probabilities of signal transmission between the units (e.g., neurons) of the network.

The input signal x(t) may comprise data used for solving a particular control task. In one or more implementations, such as those involving a robotic arm or autonomous robot, the signal x(t) may comprise a stream of raw sensor data (e.g., proximity, inertial, terrain imaging, and/or other raw sensor data) and/or preprocessed data (e.g., velocity, extracted from accelerometers, distance to obstacle, positions, and/or other preprocessed data). In some implementations, such as those involving object recognition, the signal x(t) may comprise an array of pixel values (e.g., RGB, CMYK, HSV, HSL, grayscale, and/or other pixel values) in the input image, and/or preprocessed data (e.g., levels of activations of Gabor filters for face recognition, contours, and/or other preprocessed data). In one or more implementations, the input signal x(t) may comprise desired motion trajectory, for example, in order to predict future state of the robot on the basis of current state and desired motion.

The control block 310 of FIG. 3 may comprise a probabilistic dynamic system, which may be characterized by an analytical input-output (x→y) probabilistic relationship having a conditional probability distribution associated therewith:

P=p(y|x,w) (Eqn. 11)

In Eqn. 11, the parameter w may denote various system parameters including connection efficacy, firing threshold, resting potential of the neuron, and/or other parameters. The analytical relationship of Eqn. 1 may be selected such that the gradient of ln[p(y|x,w)] with respect to the system parameter w exists and can be calculated. The framework shown in FIG. 3 may be configured to estimate rules for changing the system parameters (e.g., learning rules) so that the performance function F(x,y,r) is minimized for the current set of inputs and outputs and system dynamics S.

In some implementations, the control performance function may be configured to reflect the properties of inputs and outputs (x,y). The values F(x,y,r) may be calculated directly by the learning block 320 without relying on external signal r when providing solution of unsupervised learning tasks.

In some implementations, the value of the function F may be calculated based on a difference between the output y of the control block 310 and a reference signal yd characterizing the desired control block output. This configuration may provide solutions for supervised learning tasks, as described in detail below.

In some implementations, the value of the performance function F may be determined based on the external signal r. This configuration may provide solutions for reinforcement learning tasks, where r represents reward and punishment signals from the environment.

### Learning Block

The learning block 320 may implement learning framework according to the implementation of FIG. 3 that enables generalized learning methods without relying on calculations of the performance function F derivative in order to solve unsupervised, supervised, reinforcement, and/or other learning tasks. The block 320 may receive the input x and output y signals (denoted by the arrow 302_1, 308_1, respectively, in FIG. 3), as well as the state information 305. In some implementations, such as those involving supervised and reinforcement learning, external teaching signal r may be provided to the block 320 as indicated by the arrow 304 in FIG. 3. The teaching signal may comprise, in some implementations, the desired motion trajectory, and/or reward and punishment signals from the external environment.

In one or more implementations the learning block 320 may optimize performance of the control system (e.g., the system 300 of FIG. 3) that is characterized by minimization of the average value of the performance function F(x,y,r) as described in detail in co-owned and co-pending U.S. patent application Ser. No. 13/______ entitled “STOCHASTIC APPARATUS AND METHODS FOR IMPLEMENTING GENERALIZED LEARNING RULES”, incorporated supra. The above-referenced application describes, in one or more implementations, minimizing the average performance (F)_{x,y,r} using, for example, gradient descend algorithms where

$$\frac{\partial }{\partial {w}_{i}} {〈 F ( x , y , r ) 〉}_{x , y , r} = {〈 {〈 F ( x , y , r ) \frac{\partial }{\partial {w}_{i}} ln ( p ( y \vert x , w ) ) 〉}_{x , y} 〉}_{r} \qquad ( Eqn . 12 )$$

where:

−ln(p(y|x,w))=h(y|x,w) (Eqn. 13)

is the per-stimulus entropy of the system response (or ‘surprisal’). The probability of the external signal p(r|x,y) may be characteristic of the external environment and may not change due to adaptation. That property may allow omission of averaging over external signals r in subsequent consideration of learning rules.

As illustrated in FIG. 3, the learning block may have access to the system's inputs and outputs, and/or system internal state S. In some implementations, the learning block may be provided with additional inputs 304 (e.g., reinforcement signals, desired output, and/or current costs of control movements, etc.) that are related to the current task of the control block.

The learning block may estimate changes of the system parameters w that minimize the performance function F, and may provide the parameter adjustment information Δw to the control block 310, as indicated by the arrow 306 in FIG. 3. In some implementations, the learning block may be configured to modify the learning parameters w of the controller block. In one or more implementations (not shown), the learning block may be configured to communicate parameters w (as depicted by the arrow 306 in FIG. 3) for further use by the controller block 310, or to another entity (not shown).

By separating learning related tasks into a separate block (e.g., the block 320 in FIG. 3) from control tasks, the architecture shown in FIG. 3 may provide flexibility of applying different (or modifying) learning algorithms without requiring modifications in the control block model. In other words, the methodology illustrated in FIG. 3 may enable implementation of the learning process in such a way that regular functionality of the control aspects of the system 300 is not affected. For example, learning may be turned off and on again as required with the control block functionality being unaffected.

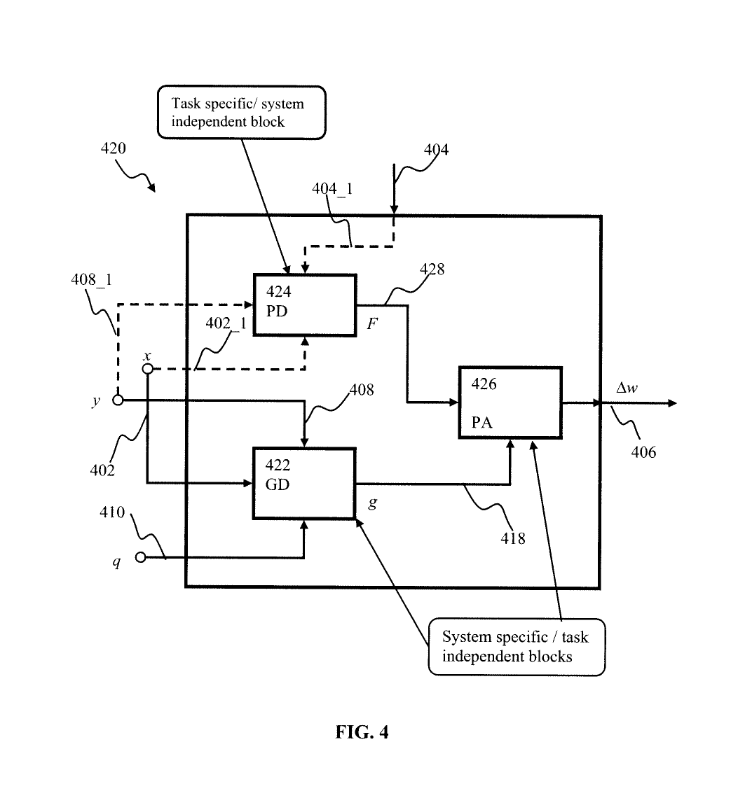

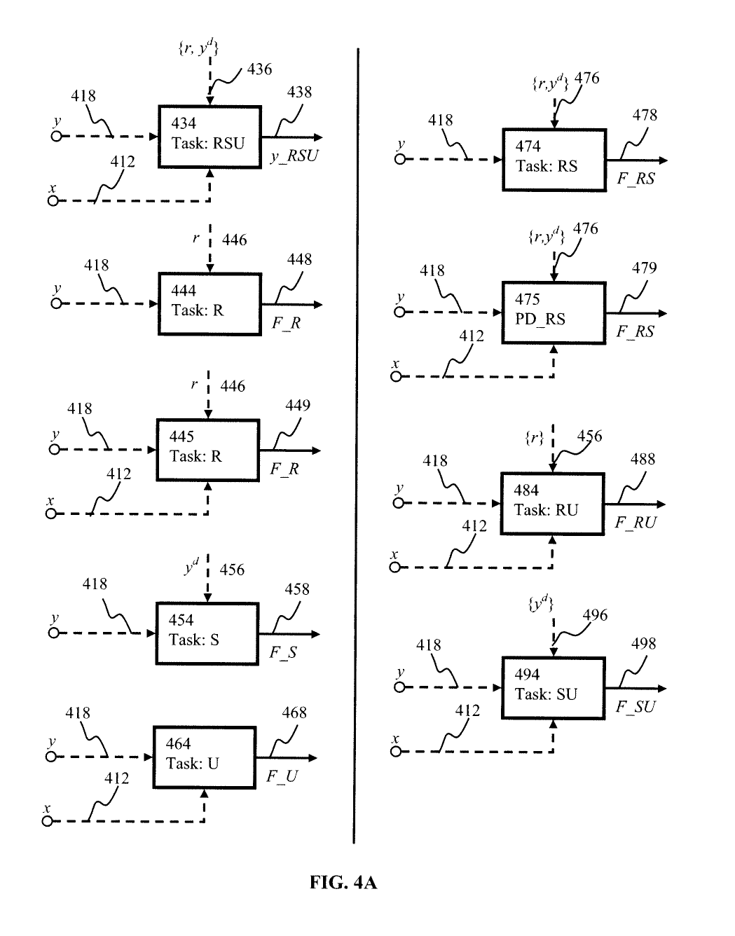

The detailed structure of the learning block 420 is shown and described with respect to FIG. 4. The learning block 420 may comprise one or more of gradient determination (GD) block 422, performance determination (PD) block 424 and parameter adaptation block (PA) 426, and/or other components. The implementation shown in FIG. 4 may decompose the learning process of the block 420 into two parts. A task-dependent/system independent part (i.e., the block 420) may implement a performance determination aspect of learning that is dependent only on the specified learning task (e.g., supervised). Implementation of the PD block 424 may not depend on particulars of the control block (e.g., block 310 in FIG. 3) such as, for example, neural network composition, neuron operating dynamics, and/or other particulars). The second part of the learning block 420, comprised of the blocks 422 and 426 in FIG. 4, may implement task-independent/system dependent aspects of the learning block operation. The implementation of the GD block 422 and PA block 426 may be the same for individual learning rules (e.g., supervised and/or unsupervised). The GD block implementation may further comprises particulars of gradient determination and parameter adaptation that are specific to the controller system 310 architecture (e.g., neural network composition, neuron operating dynamics, and/or plasticity rules). The architecture shown in FIG. 4 may allow users to modify task-specific and/or system-specific portions independently from one another, thereby enabling flexible control of the system performance. An advantage of the framework may be that the learning can be implemented in a way that does not affect the normal protocol of the functioning of the system (except of changing the parameters w). For example, there may be no need in a separate learning stage and learning may be turned off and on again when appropriate.

### Gradient Determination Block

The GD block may be configured to determine the score function g by, inter alia, computing derivatives of the logarithm of the conditional probability with respect to the parameters that are subjected to change during learning based on the current inputs x, outputs y, and state variables S, denoted by the arrows 402, 408, 410, respectively, in FIG. 4. The GD block may produce an estimate of the score function g, denoted by the arrow 418 in FIG. 4 that is independent of the particular learning task, (e.g., reinforcement, unsupervised, and/or supervised learning). In some implementations, where the learning model comprises multiple parameters wᵢ, the score function g may be represented as a vector g, comprising scores gᵢ associated with individual parameter components wᵢ.

In order to apply SF/LR methods for spiking neurons, a score function

$${g}_{i} ≡ \frac{\partial h ( y \vert x )}{\partial {w}_{i}}$$

may be calculated for individual spiking neurons parameters to be changed. If spiking patterns are viewed on finite interval length T as an input x and output y of the neuron, then the score function may take the following form:

$$\begin{matrix}{g}_{i} = \frac{\partial h ( {y}_{T} \vert {x}_{T} )}{\partial {w}_{i}} \\ = - {\sum }_{{t}_{l} ∈ {y}_{T}}^{ } \frac{1}{λ ( {t}_{l} )} \frac{\partial λ ( {t}_{l} )}{\partial {w}_{i}} + {\int }_{T}^{ } \frac{\partial λ ( s )}{\partial {w}_{i}} d s .\end{matrix} \qquad ( Eqn .14 )$$

where time moments tₗ belong to neuron's output pattern y_{T} (neuron generates spike at these time moments).

If an output of the neuron at each time moment is considered (e.g., whether there is an output spike or not), then an instantaneous value of the score function may be calculated that is a time derivative of the interval score function:

$$\begin{matrix}{g}_{i} = \frac{\partial h ( y ( t ) \vert x )}{\partial {w}_{i}} \\ = \frac{\partial λ ( t )}{\partial {w}_{i}} ( 1 - {\sum }_{{t}_{l}}^{ } \frac{δ ( t - {t}_{l} )}{λ ( t )} )\end{matrix} \qquad ( Eqn . 15 )$$

where tₗ is the times of output spikes, and δ(t) is the delta function.

For discrete time the score function for spiking pattern on interval T may be calculated as:

$${g}_{i} = \frac{\partial h ( {y}_{T} \vert {x}_{T} )}{\partial {w}_{i}} = - {\sum }_{{t}_{i} ∈ {y}_{T}} \frac{1 - Λ ( {t}_{i} )}{Λ ( {t}_{i} )} \frac{\partial λ ( {t}_{i} )}{\partial {w}_{i}} Δ t + {\sum }_{{t}_{i} ∉ {y}_{T}} \frac{\partial λ ( {t}_{i} )}{\partial {w}_{i}} \cdot Δ t \qquad ( Eqn . 16 )$$

where tₗεy_{T} denotes time steps when neuron generated a spike.

Instantaneous value of the score function in discrete time may equals:

$${g}_{i} = \frac{\partial {h}_{Δ t}}{\partial {w}_{i}} = \frac{\partial λ}{\partial {w}_{i}} ( 1 - {\sum }_{j} \frac{{δ}_{d} ( t - {t}_{l} )}{Λ ( t )} Δ t ) \qquad ( Eqn . 17 )$$

Where tₗ is the times of output spikes, and δ(t) is the Kronecker delta.

In order to calculate the score function,

$$\frac{\partial λ ( t )}{\partial {w}_{i}}$$

may be calculated, which is a derivative of the instantaneous probability density with respect to some neurons parameter wᵢ. Without loss of generality, two cases of learning are considered below: input weights learning (synaptic plasticity) and stochastic threshold tuning (intrinsic plasticity). A derivative of other less common parameters of the neuron model (e.g., membrane, synaptic dynamic, and/or other constants) may be calculated.

The neuron may receive n input spiking channels. External current to the neuron I^{ext} in the neuron's dynamic equation Eqn. 6 may be modeled as a sum of filtered and weighted input spikes from all input channels:

$${I}^{ext} = {\sum }_{i}^{n} {\sum }_{{t}_{j}^{i} ∈ {x}^{i}} {w}_{i} ɛ ( t - {t}_{j}^{i} ) \qquad ( Eqn . 18 )$$

where: i is the index of the input channel; xⁱ is the stream of input spikes on the i-th channel; tⱼⁱ is the times of input spikes in the i-th channel; wᵢ is the weight of the i-th channel; and ε(t) is a generic function that models post-synaptic currents from input spikes. In some implementations, the post-synaptic current function may be configured as: ε(t)≡δ(t), ε(t) e^{-t/t}^{ₛ} H(t), where δ(t) is a delta function, H(t) is a Heaviside function, and τₛ is a synaptic time constant.

A derivative of instantaneous probability density with respect to the i-th channel's weight may be taken using chain rule:

$$\frac{\partial λ}{\partial {w}_{i}} = {\sum }_{j} ( \frac{\partial {λ}_{i}}{\partial {q}_{j}} \cdot ∇ {w}_{i} {q}_{j} ) \qquad ( Eqn . 19 )$$

where

$$\frac{\partial λ}{\partial {q}^{r}}$$

is a vector of derivatives of instantaneous probability density with respect to the state variable; and

Sᵢ(t)=∇_{w}_{ᵢ}\vec{q} (Eqn. 20)

is the gradient of the neuron internal state with respect to the i^{th} weight (also referred to as the i-th state eligibility trace). In order to determine the state eligibility trace of Eqn. 20 for generalized neuronal model, such as, for example, described by equations Eqn. 6 and Eqn. 18, derivative with respect to the learning weight wᵢ may be determined as:

$$\frac{\partial }{\partial {w}_{i}} ( \frac{d {q}^{->}}{d t} ) = \frac{\partial }{\partial {w}_{i}} ( V ( {q}^{->} ) ) + \frac{\partial }{\partial {w}_{i}} ( {\sum }_{{t}^{out}} R ( {q}^{->} ) δ ( t - {t}^{out} ) ) + \frac{\partial }{\partial {w}_{i}} ( G ( {q}^{->} ) {I}^{ext} ) \qquad ( Eqn . 21 )$$

The order in which the derivatives in the left side of the equations are taken may be changed, and then the chain rule may be used to obtain the following equations (arguments of evolution functions are omitted):

$$\frac{d {S}_{i} ( t )}{d t} = ( {J}_{v} ( {q}^{->} ) + {J}_{G} ( {q}^{->} ) \cdot {I}^{ext} ) \cdot {S}_{i} + {\sum }_{{t}^{out}} {J}_{R} ( {q}^{->} ) \cdot {S}_{i} \cdot δ ( t - {t}^{out} ) + G ( {q}^{->} ) {\sum }_{{t}_{j}^{i} ∈ {x}^{j}} ɛ ( t - {t}_{j}^{i} ) , \qquad ( Eqn . 22 )$$

where J_{F}, J_{R}, J_{G} are Jacobian matrices of the respective evolution functions V, R, G.

As an example, evaluating Jacobean matrices IF neuron may produce:

J_{V}=−C;J_{R}=−1;G(\vec{q})=1;J_{G}=0, (Eqn. 23)

so Eqn. 22 for the i-th state eligibility trace may take the following form:

$$\frac{d}{d t} {u}_{{w}_{i}} = - {Cu}_{{w}_{i}} - {\sum }_{{t}^{out}} {u}_{{w}_{i}} \cdot δ ( t - {t}^{out} ) + {\sum }_{{t}_{j}^{i} ∈ {x}^{i}} ɛ ( t - {t}_{j}^{i} ) \qquad ( Eqn . 24 )$$

where u_{w}_{ᵢ} denotes derivative of the state variable (e.g., voltage) with respect to the i-th weight.

A solution of Eqn. 24 may represent post-synaptic potential for the i-th unit and may be determined as a sum of all received input spikes at the unit (e.g., a neuron), where the unit is reset to zero after each output spike:

$${u}_{{w}_{i}} = {\sum }_{{t}_{j}^{i} ∈ {x}^{i}} {\int }_{- ∞}^{t} {e}^{- ( t - τ ) C} ɛ ( τ - {t}_{j}^{i} ) = {\sum }_{{t}_{j}^{i} ∈ {x}^{i}} α ( t - {t}_{j}^{i} ) \qquad ( Eqn . 25 )$$

where α(t) is post-synaptic potential (PSP) from the j^{th} input spike.

Applying the framework of Eqn. 22-Eqn. 25 to a previously described neuronal (hereinafter IZ neuronal), the Jacobian matrices of the respective evolution functions F, R, G may be expressed as:

$${J}_{v} = ( \begin{matrix}0.08 v ( t ) + 5 & - 1 \\ ab & a\end{matrix} ) ; {J}_{R} = ( \begin{matrix}- 1 & 0 \\ 0 & 0\end{matrix} ) ; G ( {q}^{->} ) = ( \begin{matrix}1 \\ 0\end{matrix} ) ; {J}_{G} = ( \begin{matrix}0 \\ 0\end{matrix} ) \qquad ( Eqn . 26 )$$

The IZ neuronal model may further be characterized using two first-order nonlinear differential equations describing time evolution of synaptic weights associated with each pre-synaptic connection into a neuron, in the following form:

$$\frac{d}{d t} {v}_{{w}_{i}} = ( 0.08 v + 5 ) {v}_{{w}_{i}} - {u}_{{w}_{i}} - {\sum }_{{t}^{out}} {u}_{{w}_{i}} \cdot δ ( t - {t}^{out} ) + {\sum }_{{t}_{j}^{i} ∈ {x}^{i}} ɛ ( t - {t}_{j}^{i} ) \\ \frac{d}{d t} {u}_{{w}_{i}} = ab {v}_{{w}_{i}} - a {u}_{{w}_{i}} \qquad ( Eqn . 27 )$$

When using the exponential stochastic threshold configured as:

λ=λ₀e^{κ(v(t)-θ),} (Eqn. 28)

Then the derivative of the IPD for IZ neuronal neuron becomes:

$$\frac{\partial λ}{\partial {w}_{i}} = {v}_{{w}_{i}} κλ ( t ) . \qquad ( Eqn . 29 )$$

If we use the exponential stochastic threshold Eqn. 2, the final expression for the derivative of instantaneous probability

$$\frac{\partial λ ( t )}{\partial w}$$

for IF neuron becomes:

$$\frac{\partial λ}{\partial {w}_{i}} = \frac{\partial λ}{\partial u} \frac{\partial u}{\partial {w}_{i}} = κλ ( t ) {\sum }_{{t}_{j}^{i} ∈ {x}^{i}} α ( t - {t}_{j}^{i} ) \qquad ( Eqn . 30 )$$

Combining Eqn. 30 with Eqn. 15 and Eqn. 17 we obtain score function values for the stochastic Integrate-and-Fire neuron in continuous time-space as:

$${g}_{i} = \frac{\partial h ( y ( t ) \vert x )}{\partial {w}_{i}} = κ {\sum }_{{t}_{j}^{i} ∈ {x}^{i}} α ( t - {t}_{j}^{i} ) ( λ ( t ) - {\sum }_{{t}^{out} ∈ y} δ ( t - {t}^{out} ) ) \qquad ( Eqn . 31 )$$

and in discrete time:

$${g}_{i} = \frac{\partial {h}_{Δ t} ( y ( t ) \vert x )}{\partial {w}_{i}} = κλ ( t ) {\sum }_{{t}_{j}^{i} ∈ {x}^{i}} α ( t - {t}_{j}^{i} ) ( 1 - {\sum }_{{t}^{out} ∈ y} \frac{{δ}_{d} ( t - {t}^{out} )}{Λ ( t )} ) Δ t \qquad ( Eqn . 32 )$$

In one or more implementations, the gradient determination block may be configured to determine the score function g based on particular pre-synaptic inputs into the neuron(s), neuron post-synaptic outputs, and internal neuron state, according, for example with Eqn. 15. Furthermore, in some implementations, using the methodology described herein and providing description of neurons dynamics and stochastic properties in textual form, as shown and described in detail with respect to FIG. 19 below, advantageously allows the use of analytical mathematics computer aided design (CAD) tools in order to automatically obtain score function, such as for example Eqn. 32.

### Performance Determination Block

The PD block may be configured to determine the performance function F based on the current inputs x, outputs y, and/or training signal r, denoted by the arrow 404 in FIG. 4. In some implementations, the external signal r may comprise the reinforcement signal in the reinforcement learning task. In some implementations, the external signal r may comprise reference signal in the supervised learning task. In some implementations, the external signal r comprises the desired output, current costs of control movements, and/or other information related to the current task of the control block (e.g., block 310 in FIG. 3). Depending on the specific learning task (e.g., reinforcement, unsupervised, or supervised) some of the parameters x, y, r may not be required by the PD block illustrated by the dashed arrows 402_1, 408_1, 404_1, respectively, in FIG. 4A The learning apparatus configuration depicted in FIG. 4 may decouple the PD block from the controller state model so that the output of the PD block depends on the learning task and is independent of the current internal state of the control block.

### Generalized Performance Determination

In some implementations, the PD block may transmit the external signal r to the learning block (as illustrated by the arrow 404_1) so that:

F(t)=r(t), (Eqn. 33)

where signal r provides reward and/or punishment signals from the external environment. By way of illustration, a mobile robot, controlled by spiking neural network, may be configured to collect resources (e.g., clean up trash) while avoiding obstacles (e.g., furniture, walls). In this example, the signal r may comprise a positive indication (e.g., representing a reward) at the moment when the robot acquires the resource (e.g., picks up a piece of rubbish) and a negative indication (e.g., representing a punishment) when the robot collides with an obstacle (e.g., wall). Upon receiving the reinforcement signal r, the spiking neural network of the robot controller may change its parameters (e.g., neuron connection weights) in order to maximize the function F (e.g., maximize the reward and minimize the punishment).

In some implementations, the PD block may determine the performance function by comparing current system output with the desired output using a predetermined measure (e.g., a distance d):

F(t)=d(y(t),y^{d}(t)), (Eqn. 34)

where y is the output of the control block (e.g., the block 310 in FIG. 3) and r=y^{d} is the external reference signal indicating the desired output that is expected from the control block. In some implementations, the external reference signal r may depend on the input x into the control block. In some implementations, the control apparatus (e.g., the apparatus 300 of FIG. 3) may comprise a spiking neural network configured for pattern classification. A human expert may present to the network an exemplary sensory pattern x and the desired output y^{d} that describes the input pattern x class. The network may change (e.g., adapt) its parameters w to achieve the desired response on the presented pairs of input x and desired response y^{d}. After learning, the network may classify new input stimuli based on one or more past experiences.

In some implementations, such as when characterizing a control block utilizing analog output signals, the distance function may be determined using the squared error estimate as follows:

F(t)=(y(t)−y^{d}(t))². (Eqn. 35)

In some implementations, such as those applicable to control blocks using spiking output signals, the distance measure may be determined using the squared error of the convolved signals y, y^{d} as follows:

F=[(y*α)−(y^{d}*β)]², (Eqn. 36)

where α, β are finite impulse response kernels. In some implementations, the distance measure may utilize the mutual information between the output signal and the reference signal.

In some implementations, the PD may determine the performance function by comparing one or more particular characteristic of the output signal with the desired value of this characteristic:

F=[ƒ(y)−ƒ¹(y)]², (Eqn. 37)

where ƒ is a function configured to extract the characteristic (or characteristics) of interest from the output signal y. By way of example useful with spiking output signals, the characteristic may correspond to a firing rate of spikes and the function ƒ(y) may determine the mean firing from the output. In some implementations, the desired characteristic value may be provided through the external signal as

r=ƒ¹(y). (Eqn. 38)

In some implementations, the ƒ¹(y) may be calculated internally by the PD block.

In some implementations, the PD block may determine the performance function by calculating the instantaneous mutual information i between inputs and outputs of the control block as follows:

F=i(x,y)=−ln(p(y))+ln(p(y|x), (Eqn. 39)

where p(y) is an unconditioned probability of the current output. It is noteworthy that the average value of the instantaneous mutual information may equal the mutual information I(x,y). This performance function may be used to implement ICA (unsupervised learning).

In some implementations, the PD block may determines the performance function by calculating the unconditional instantaneous entropy h of the output of the control block as follows:

F=h(x,y)=−ln(p(y)). (Eqn. 40)

where p(y) is an unconditioned probability of the current output. It is noteworthy that the average value of the instantaneous unconditional entropy may equal the unconditional H(x,y). This performance function may be used to reduce variability in the output of the system for adaptive filtering.

In some implementations, the PD block may determine the performance function by calculating the instantaneous Kullback-Leibler divergence d_{KL} between the output probability distribution p(y|x) of the control block and some desired probability distribution θ(y|x) as follows:

F=d_{KL}(P,θ)=ln(p(y|x))−ln(θ(y|x)). (Eqn. 41)

The average value of the instantaneous Kulback-Leibler divergence may be referred to as the Kulback-Leibler divergence D_{KL}(p, θ). The performance function of Eqn. 41 may be applied in unsupervised learning tasks in order to restrict a possible output of the system. For example, if θ(y) is a Poisson distribution of spikes with some firing rate R, then minimization of this performance function may force the neuron to have the same firing rate R.

In some implementations, the PD block may determine the performance function for the sparse coding. The sparse coding task may be an unsupervised learning task where the adaptive system may discover hidden components in the data that describes data the best with a constraint that the structure of the hidden components should be sparse:

F=∥x−A(y,w)∥²+∥y∥², (Eqn. 42)

where the first term quantifies how close the data x can be described by the current output y, where A(y,w) is a function that describes how to decode an original data from the output. The second term may calculate a norm of the output and may imply restrictions on the output sparseness.

A learning framework of the present innovation may enable generation of learning rules for a system, which may be configured to solve several completely different tasks-types simultaneously. For example, the system may learn to control an actuator while trying to extract independent components from movement trajectories of this actuator. The combination of tasks may be done as a linear combination of the performance functions for each particular problem:

F=C(F₁,F₂, . . . ,Fₙ), (Eqn. 43)

where: F₁, F₂, . . . , Fₙ are performance function values for different tasks; and C is a combination function.

In some implementations, the combined performance function C may comprise a weighted linear combination of individual cost functions corresponding to individual learning tasks:

C(F₁,F₁, . . . ,F₁)=ΣₖaₖFₖ, (Eqn. 44)

where aₖ are combination weights.

It is recognized by those killed in the arts that linear performance function combination described by Eqn. 44 illustrates one particular implementation of the disclosure and other implementations (e.g., a nonlinear combination) may be used as well.

### Accelerated Learning Via Monotonic Transformations

In one or more implementations, a monotonic transformation may be used in conjunction with the performance function described for example, by Eqn. 33-Eqn. 48 above. In one such realization, the transformation may comprise an addition of a constant term to the

$${〈 ( F + {F}_{0} ) {g}_{i} 〉}_{x , y} = {〈 F {g}_{i} 〉}_{x , y} - {F}_{0} {\sum }_{x , y}^{{T}_{av}} \frac{\partial ln ( p ( y \vert x ) )}{\partial {w}_{i}} p ( x , y ) = {〈 F {g}_{i} 〉}_{x , y} \qquad ( Eqn . 45 )$$

where F₀ comprises a transformation parameter. In some implementations, the transformation parameter F₀ may be configured to be constant over averaging time scale Tₐᵥ of Eqn. 45. The time scale Tₐᵥ may be configured longer, compared to the network update time scale, so that when the transformed performance function is averaged according, for example to Eqn. 45, the result may be free from systematic deviation (i.e., bias). In some implementations, the network update timescale may be selected between 1 ms and 20 ms. In some implementations, the transformation parameter may be configured to vary slowly over the time scale Tₐᵥ such that when averaged it may be characterized by a constant value <F0>. In other words, the performance function transformation, when constructed as described above, may not bias the performance gradient on the time scale that is longer compared to the update time scale.

In one or more implementations, an arbitrary monotonous transformation ℑ(F) may be applied to the performance function, provided it does not affect the position of its extremum (with respect to the parameters x, y, w).

In some implementation, when F is positive, then the transformation may comprise ℑ(F)=F², ℑ(F)=\sqrt{F}, ℑ(F)=log(F), ℑ(F)=e^{F}, and/or ℑ(F)=Fⁿ, n≠0.

In one or more implementations, the performance F may comprise positive reward signal R⁺ (e.g., such as the distance between the desired and actual vehicle position) and the transformation ℑ(F) may be used, for example, to normalize the reward as follows:

ℑ(F)=1−e^{-kR}^{⁺} (Eqn. 46)

where k is the scale parameter determined. The transformation of Eqn. 46 normalizes the reward into a range between 0 to 1, thereby limiting the maximum changes to the learning parameter w when the reward is large. By way of illustration, if the reward value is equal to 10,000, the transformed reward is merely 0.0003. Hence, the transformation alleviates the need to modify learning parameter (e.g., the parameter γ in Eqn. 57). Instead, the normalization of the reward aids the gradient descend method by, inter alia, providing appropriate small increment in the learning parameter w.

In one or more implementations, the transformation may be applied to the distance between teacher output and system output that may be defined in accordance with Eqn. 35.

The learning implementation comprising performance function transformations, such as, for example, those described by Eqn. 45 shift gradient of the performance function in a particular direction on the time scale, that is smaller than the averaging time scale but may be comparable to the update time scale. Such shift may advantageously lead to stochastic drift of parameters and may enhance exploration capabilities of the adaptive controller apparatus (e.g., the apparatus 320 of FIG. 3. The direction of the shift may be selected, in some implementations, based on an iterative process where the overall performance is used to determine the most beneficial direction of the shift.

In one or more implementations, learning speed of the learning apparatus may be increased by subtracting a baseline performance from instantaneous performance function estimates F^{cur}. In one such implementation, the PD block (e.g., the block 424 of FIG. 4) may be configured to compute and remove the baseline form the performance function output as follows:

F(t)=F(t)^{cur}− [symbol] F [symbol] (Eqn. 47)

where:

F^{cur}(t)—is the current value of the performance function; and

[symbol] F [symbol] —is time average of the performance function (interval average or running average).

In some implementations, the time average of the performance function may comprise an interval average, where learning occurs over a predetermined interval. A current value of the performance function may be determined at individual steps within the interval and may be averaged over all steps.

In some implementations, the time average of the performance function may comprise a running average, where the current value of the cost function may be low-pass filtered according to:

$$\frac{d F ( t )}{d t} = - τ F ( t ) + {F ( t )}^{cur} , \qquad ( Eqn . 48 )$$

thereby producing a running average output.

Referring now to FIG. 4A, different implementations of the performance determination block (e.g., the block 424 of FIG. 4) are shown. The PD block implementation denoted 434 may be configured to simultaneously implement reinforcement, supervised and unsupervised (RSU) learning rules; and/or receive the input signal x(t) 412, the output signal y(t) 418, and/or the learning signal 436. The learning signal 436 may comprise the reinforcement component r(t) and the desired output (teaching) component y^{d}(t). In one or more implementations, the output performance function F_RSU 438 of the RSUPD block may be determined in accordance with:

Fₛᵤᵣ=aFₛᵤₚ+bF_{reinf}+c(−Fᵤₙₛᵤₚ) (Eqn. 49)

where Fₛᵤₚ is described by, for example, Eqn. 34, Fᵤₙₛᵤₚ is the cost function for the unsupervised learning tasks, and a, c are coefficients determining relative contribution of each cost component to the combined cost function. By varying the coefficients a, c during different simulation runs of the spiking network, effects of relative contribution of individual learning methods on the network learning performance may be investigated.

The PD blocks 444, 445, may implement the reinforcement (R) learning rule. The output 448 of the block 444 may be determined based on the output signal y(t) 418 and the reinforcement signal r(t) 446. In one or more implementations, the output 448 of the RSUPD block may be determined in accordance with Eqn. 38. The performance function output 449 of the block 445 may be determined based on the input signal x(t), the output signal y(t), and/or the reinforcement signal r(t).

The PD block implementation denoted 454, may be configured to implement supervised (S) learning rules to generate performance function F_S 458 that is dependent on the output signal y(t) value 418 and the teaching signal y^{d}(t) 456. In one or more implementations, the output 458 of the PD 454 block may be determined in accordance with Eqn. 34-Eqn. 37.

The output performance function 468 of the PD block 464 implementing unsupervised learning may be a function of the input x(t) 412 and the output y(t) 418. In one or more implementations, the output 468 may be determined in accordance with Eqn. 39-Eqn. 42.

The PD block implementation denoted 474 may be configured to simultaneously implement reinforcement and supervised (RS) learning rules. The PD block 474 may not require the input signal x(t), and may receive the output signal y(t) 418 and the teaching signals r(t), y^{d}(t) 476. In one or more implementations, the output performance function F RS 478 of the PD block 474 may be determined in accordance with Eqn. 43, where the combination coefficient for the unsupervised learning is set to zero. By way of example, in some implementations reinforcement learning task may be to acquire resources by the mobile robot, where the reinforcement component r(t) provides information about acquired resources (reward signal) from the external environment, while at the same time a human expert shows the robot what should be desired output signal y^{d}(t) to optimally avoid obstacles. By setting a higher coefficient to the supervised part of the performance function, the robot may be trained to try to acquire the resources if it does not contradict with human expert signal for avoiding obstacles.

The PD block implementation denoted 475 may be configured to simultaneously implement reinforcement and supervised (RS) learning rules. The PD block 475 output may be determined based the output signal 418, the learning signals 476, comprising the reinforcement component r(t) and the desired output (teaching) component y (t) and on the input signal 412, that determines the context for switching between supervised and reinforcement task functions. By way of example, in some implementations, reinforcement learning task may be used to acquire resources by the mobile robot, where the reinforcement component r(t) provides information about acquired resources (reward signal) from the external environment, while at the same time a human expert shows the robot what should be desired output signal y_{d}(t) to optimally avoid obstacles. By recognizing obstacles, avoidance context on the basis of some clues in the input signal, the performance signal may be switched between supervised and reinforcement. That may allow the robot to be trained to try to acquire the resources if it does not contradict with human expert signal for avoiding obstacles. In one or more implementations, the output performance function 479 of the PD 475 block may be determined in accordance with Eqn. 43, where the combination coefficient for the unsupervised learning is set to zero.

The PD block implementation denoted 484 may be configured to simultaneously implement reinforcement, and unsupervised (RU) learning rules. The output 488 of the block 484 may be determined based on the input and output signals 412, 418, in one or more implementations, in accordance with Eqn. 43. By way of example, in some implementations of sparse coding (unsupervised learning), the task of the adaptive system on the robot may be not only to extract sparse hidden components from the input signal, but to pay more attention to the components that are behaviorally important for the robot (that provides more reinforcement after they can be used).

The PD block implementation denoted 494, which may be configured to simultaneously implement supervised and unsupervised (SU) learning rules, may receive the input signal x(t) 412, the output signal y(t) 418, and/or the teaching signal y^{d}(t) 436. In one or more implementations, the output performance function F_SU 438 of the SU PD block may be determined in accordance with:

Fₛᵤ=aFₛᵤₚ+c(−Fᵤₙₛᵤₚ). (Eqn. 50)

where Fₛᵤₚ is described by, for example, Eqn. 34, Fᵤₙₛᵤₚ is the cost function for the unsupervised learning tasks, and a, c are coefficients determining relative contribution of each cost component to the combined cost function. By varying the coefficients a, c during different simulation runs of the spiking network, effects of relative contribution of individual learning methods on the network learning performance may be investigated.

In order to describe the cost function of the unsupervised learning, a Kullback-Leibler divergence between two point processes may be used:

Fᵤₙₛᵤₚ=ln(p(t))−ln(p^{d}(t)) (Eqn. 51)

where p(t) is probability of the actual spiking pattern generated by the network, and p^{d}(t) is the probability of a spiking pattern generated by Poisson process. The unsupervised learning task may serve to minimize the function of Eqn. 51 such that when the two probabilities p(t)=p^{d}(t) are equal at all times, then the network generates output spikes according to Poisson distribution.

The composite cost function for simultaneous unsupervised and supervised learning may be expressed as a linear combination of Eqn. 34 and Eqn. 51:

$$\begin{matrix}F = {aF}_{sup} + c ( - {F}_{unsup} ) = \\ = a {\int }_{- ∞}^{t} ( {\sum }_{i} δ ( t - {t}_{i} ) {e}^{- ( t - s ) / {τ}_{d}} d s ) ( {\sum }_{i} δ ( t - {t}_{i}^{d} ) d t - C ) + \\ c ( ln ( {p}^{b} ( t ) ) - ln ( p ( t ) ) )\end{matrix} \qquad ( Eqn . 52 )$$

By the way of example, the stochastic learning system (that is associated with the PD block implementation 494) may be configured to learn to implement unsupervised data categorization (e.g., using sparse coding performance function), while simultaneously receiving external signal that is related to the correct category of particular input signals. In one or more implementations such reward signal may be provided by a human expert.

### Performance Determination for Spiking Neurons

In one or more implementations of reinforcement learning, the PD block (e.g., the block 424 of FIG. 4) may generate the performance signal based on analog and/or spiking reward signal r (e.g., the signal 404 of FIG. 4). In one implementation, the performance signal F (e.g., the signal 428 of FIG. 4) may comprise the reward signal r(t), transmitted to the PA block (e.g., the block 426 of FIG. 4) by the PD block.

In one or more implementations related to analog reward signal, in order to reduce computational load on the PA block related to application of weight changes, the PD block may transform the analog reward r(t) into spike form.

In one or more implementations of supervised learning, the current performance F may be determined based on the output of the neuron and the external reference signal (e.g., the desired output y^{d}(t)). For example, a distance measure may be calculated using a low-pass filtered version of the desired y^{d}(t) and actual y(t) outputs. In some implementations, a running distance between the filtered spike trains may be determined according to:

$$F ( x ( t ) , y ( t ) ) = {( {\int }_{- ∞}^{t} y ( s ) a ( τ - s ) d τ - {\int }_{- ∞}^{t} {y}^{d} ( s ) b ( τ - s ) d τ )}^{2} \qquad ( Eqn . 53 )$$

where:

$$y ( t ) = {\sum }_{i} δ ( t - {t}_{i}^{out} ) , {y}^{d} ( t ) = {\sum }_{j} δ ( t - {t}_{j}^{d} ) ,$$

with y(t) and y^{d}(t) being the actual and desired output spike trains; δ(t) is the Dirac delta function; tᵢ^{out}, tⱼ^{d} are the output and desired spike times, respectively; and a(t), b(t) are positive finite-response kernels. In some implementations, the kernel a(t) may comprise an exponential trace: a(t)=e^{-t/τ}^{ₐ}.

In some implementations of supervised learning, spiking neuronal network may be configured to learns to minimize a Kullback-Leibler distance between the actual and desired output:

F(x(t),y(t))=D_{KL}(y(t)∥r(t)). (Eqn. 54

In some implementations, if r(t) is a Poisson spike train with a fixed firing rate, the D_{KL} learning may enable stabilization of the neuronal firing rate.

In some implementations of supervised learning, referred to as the “information bottleneck”, the performance maximization may comprise minimization of the mutual information between the actual output y(t) and some reference signal r(t). For a given input and output, the performance function may be expressed as:

F(x(t),y(t))=I(y(t),r(t)). (Eqn. 55)

In one or more implementations of unsupervised learning, the cost function may be obtained by a minimization of the conditional informational entropy of the output spiking pattern:

F(x,y)=H(y|x) (Eqn. 56)

so as to provide a more stable neuron output y for a given input x.

### Parameter Changing Block

The parameter changing PA block (the block 426 in FIG. 4) may determine changes of the control block parameters Δwᵢ according to a predetermined learning algorithm, based on the performance function F and the gradient g it receives from the PD block 424 and the GD block 422, as indicated by the arrows marked 428, 430, respectively, in FIG. 4. Particular implementation of the learning algorithm within the block 426 may depend on the type of the learning task (e.g., online or batch learning) used by the learning block 320 of FIG. 3.

Several exemplary implementations of PA learning algorithms applicable with spiking control signals are described below. In some implementations, the PA learning algorithms may comprise a multiplicative online learning rule, where control parameter changes are determined as follows:

Δ [symbol] (t)=γF(t) [symbol] (t) (Eqn. 57)

where γ is the learning rate configured to determine speed of learning adaptation. The learning method implementation according to (Eqn. 57) may be advantageous in applications where the performance function F(t) may depend on the current values of the inputs x, outputs y, and/or signal r.

In some implementations, the control parameter adjustment Δw may be determined using an accumulation of the score function gradient and the performance function values, and applying the changes at a predetermined time instance (corresponding to, e.g., the end of the learning epoch):

$$Δ {w}^{r} ( t ) = \frac{γ}{{N}^{2}} \cdot {\sum }_{i = 0}^{N - 1} F ( t - i Δ t ) \cdot {\sum }_{i = 0}^{N - 1} {g}^{r} ( t - i Δ t ) , \qquad ( Eqn . 58 )$$

where: T is a finite interval over which the summation occurs; N is the number of steps; and Δt is the time step determined as T|N. The summation interval T in Eqn. 58 may be configured based on the specific requirements of the control application. By way of illustration, in a control application where a robotic arm is configured to reaching for an object, the interval may correspond to a time from the start position of the arm to the reaching point and, in some implementations, may be about 1 s-50 s. In a speech recognition application, the time interval T may match the time required to pronounce the word being recognized (typically less than 1 s-2 s). In some implementations of spiking neuronal networks, Δt may be configured in range between 1 ms and 20 ms, corresponding to 50 steps (N=50) in one second interval.

The method of Eqn. 58 may be computationally expensive and may not provide timely updates. Hence, it may be referred to as the non-local in time due to the summation over the interval T. However, it may lead to unbiased estimation of the gradient of the performance function.

In some implementations, the control parameter adjustment Δwᵢ may be determined by calculating the traces of the score function eᵢ(t) for individual parameters wᵢ. In some implementations, the traces may be computed using a convolution with an exponential kernel β as follows:

\vec{e}(t+Δt)=β\vec{e}(t)+\vec{g}(t), (Eqn. 59)

where β is the decay coefficient. In some implementations, the traces may be determined using differential equations:

$$\frac{d}{d t} {e}^{->} ( t ) = - τ {e}^{->} ( t ) + {g}^{->} ( t ) . \qquad ( Eqn . 60 )$$

The control parameter w may then be adjusted as:

\vec{Δw}(t)=γF(t)\vec{e}(t), (Eqn. 61)

where γ is the learning rate. The method of Eqn. 59-Eqn. 61 may be appropriate when a performance function depends on current and past values of the inputs and outputs and may be referred to as the OLPOMDP algorithm. While it may be local in time and computationally simple, it may lead to biased estimate of the performance function. By way of illustration, the methodology described by Eqn. 59-Eqn. 61 may be used, in some implementations, in a rescue robotic device configured to locate resources (e.g., survivors, or unexploded ordinance) in a building. The input x may correspond to the robot current position in the building. The reward r (e.g., the successful location events) may depend on the history of inputs and on the history of actions taken by the agent (e.g., left/right turns, up/down movement, and/or other actions taken by the agent).

In some implementations, the control parameter adjustment Δw determined using methodologies of the Eqns. 16, 17, 19 may be further modified using, in one variant, gradient with momentum according to:

Δ [symbol] (t) [symbol] μΔ [symbol] (t−Δt)+Δ [symbol] (t), (Eqn. 62)

where μ is the momentum coefficient. In some implementations, the sign of gradient may be used to perform learning adjustments as follows:

$$Δ {w}_{i} ( t ) ⇒ \frac{Δ {w}_{i} ( t )}{\vert Δ {w}_{i} ( t ) \vert} . \qquad ( Eqn . 63 )$$

In some implementations, gradient descend methodology may be used for learning coefficient adaptation.

In some implementations, the gradient signal g, determined by the PD block 422 of FIG. 4, may be subsequently modified according to another gradient algorithm, as described in detail below. In some implementations, these modifications may comprise determining a natural gradient, as follows:

Δ [symbol] = [symbol] [symbol] · [symbol] ^{T} [symbol] _{x,y}⁻¹· [symbol] [symbol] ·F [symbol] _{x,y} (Eqn. 64)

where [symbol] \vec{g}\vec{g}^{T} [symbol] _{x,y} is the Fisher information metric matrix. Applying the following transformation to Eqn. 21:

[symbol]

[symbol]

Δ [symbol] ^{T}Δ [symbol] −F) [symbol] _{x,y}=0, (Eqn. 65)

natural gradient from linear regression task may be obtained as follows:

GΔ\vec{w}=\vec{F} (Eqn. 66)

where G=[\vec{g₀^{T}}, . . . , \vec{gₙ^{T}}] is a matrix comprising n samples of the score function g, \vec{F^{T}}=[F₀, . . . , Fₙ] is the a vector of performance function samples, and n is a number of samples that should be equal or greater of the number of the parameters wᵢ. While the methodology of Eqn. 64-Eqn. 66 may be computationally expensive, it may help dealing with ‘plateau’-like landscapes of the performance function.

### Signal Processing Apparatus

In one or more implementations, the generalized learning framework described supra may enable implementing signal processing blocks with tunable parameters w. Using the learning block framework that provides analytical description of individual types of signal processing block may enable it to automatically calculate the appropriate score function

$$\frac{\partial h ( x \vert y )}{\partial {w}_{i}}$$

for individual parameters of the block. Using the learning architecture described in FIG. 3, a generalized implementation of the learning block may enable automatic changes of learning parameters w by individual blocks based on high level information about the subtask for each block. A signal processing system comprising one or more of such generalized learning blocks may be capable of solving different learning tasks useful in a variety of applications without substantial intervention of the user. In some implementations, such generalized learning blocks may be configured to implement generalized learning framework described above with respect to FIGS. 3-4A and delivered to users. In developing complex signal processing systems, the user may connect different blocks, and/or specify a performance function and/or a learning algorithm for individual blocks. This may be done, for example, with the special graphical user interface (GUI), which may allow blocks to be connected using a mouse or other input peripheral by clicking on individual blocks and using defaults or choosing the performance function and a learning algorithm from a predefined list. Users may not need to re-create a learning adaptation framework and may rely on the adaptive properties of the generalized learning blocks that adapt to the particular learning task. When the user desires to add a new type of block into the system, he may need to describe it in a way suitable to automatically calculate a score functions for individual parameters.

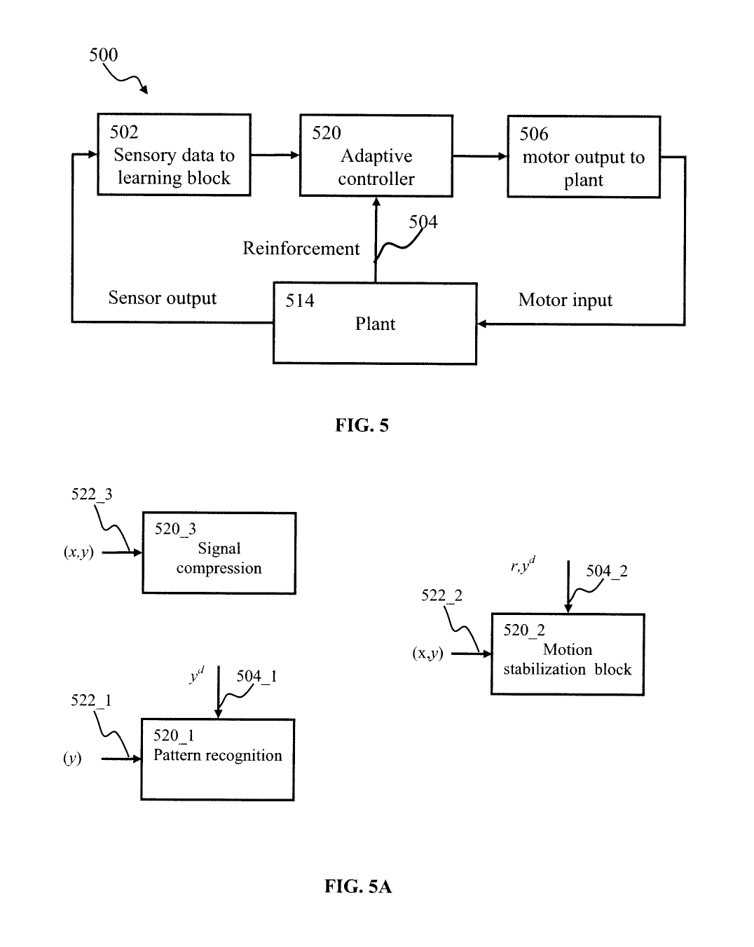

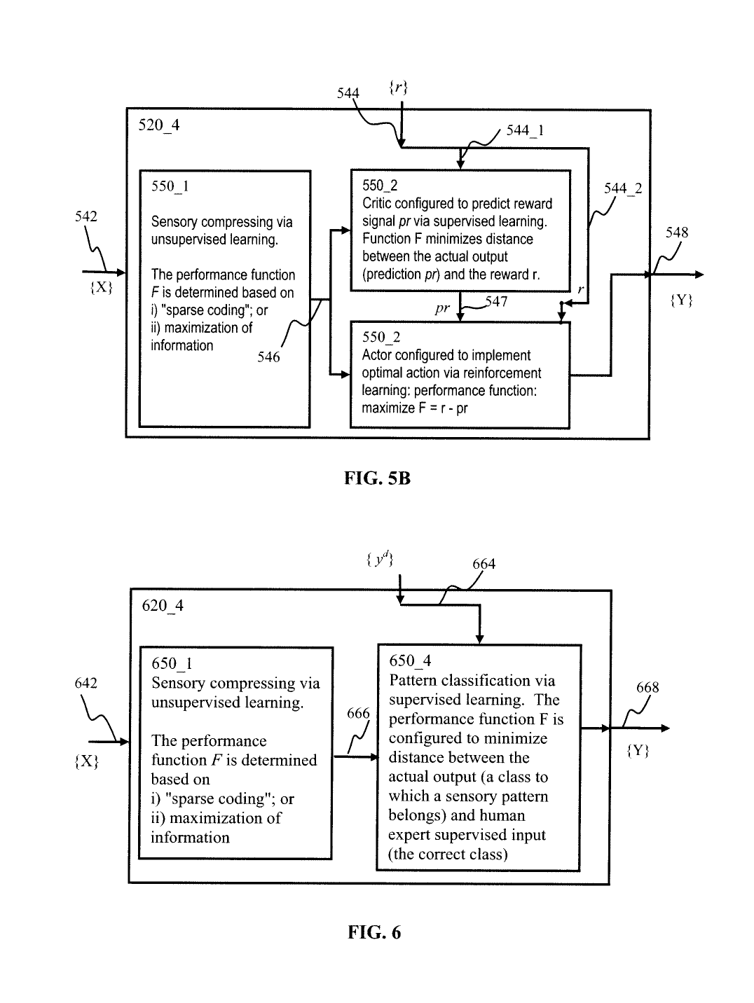

FIG. 5 illustrates one exemplary implementation of a robotic apparatus 500 comprising adaptive controller apparatus 512. In some implementations, the adaptive controller 520 may be configured similar to the apparatus 300 of FIG. 3 and may comprise generalized learning block (e.g., the block 420), configured, for example according to the framework described above with respect to FIG. 4, supra, is shown and described. The robotic apparatus 500 may comprise the plant 514, corresponding, for example, to a sensor block and a motor block (not shown). The plant 514 may provide sensory input 502, which may include a stream of raw sensor data (e.g., proximity, inertial, terrain imaging, and/or other raw sensor data) and/or preprocessed data (e.g., velocity, extracted from accelerometers, distance to obstacle, positions, and/or other preprocessed data) to the controller apparatus 520. The learning block of the controller 520 may be configured to implement reinforcement learning, according to, in some implementations Eqn. 38, based on the sensor input 502 and reinforcement signal 504 (e.g., obstacle collision signal from robot bumpers, distance from robotic arm endpoint to the desired position), and may provide motor commands 506 to the plant. The learning block of the adaptive controller apparatus (e.g., the apparatus 520 of FIG. 5) may perform learning parameter (e.g., weight) adaptation using reinforcement learning approach without having any prior information about the model of the controlled plant (e.g., the plant 514 of FIG. 5). The reinforcement signal r(t) may inform the adaptive controller that the previous behavior led to “desired” or “undesired” results, corresponding to positive and negative reinforcements, respectively. While the plant 514 must be controllable (e.g., via the motor commands in FIG. 5) and the control system may be required to have access to appropriate sensory information (e.g., the data 502 in FIG. 5), detailed knowledge of motor actuator dynamics or of structure and significance of sensory signals may not be required to be known by the controller apparatus 520.

It will be appreciated by those skilled in the arts that the reinforcement learning configuration of the generalized learning controller apparatus 520 of FIG. 5 is used to illustrate one exemplary implementation of the disclosure and myriad other configurations may be used with the generalized learning framework described herein. By way of example, the adaptive controller 520 of FIG. 5 may be configured for: (i) unsupervised learning for performing target recognition, as illustrated by the adaptive controller 520_3 of FIG. 5A, receiving sensory input and output signals (x,y) 522_3; (ii) supervised learning for performing data regression, as illustrated by the adaptive controller 520_3 receiving output signal 522_1 and teaching signal 504_1 of FIG. 5A; and/or (iii) simultaneous supervised and unsupervised learning for performing platform stabilization, as illustrated by the adaptive controller 520_2 of FIG. 5A, receiving input 522_2 and learning 504_2 signals.

FIGS. 5B-6 illustrate dynamic tasking by a user of the adaptive controller apparatus (e.g., the apparatus 320 of FIG. 3A or 520 of FIG. 5, described supra) in accordance with one or more implementations.

A user of the adaptive controller 520_4 of FIG. 5B may utilize a user interface (textual, graphics, touch screen, etc.) in order to configure the task composition of the adaptive controller 520_4, as illustrated by the example of FIG. 5B. By way of illustration, at one instance for one application the adaptive controller 520_4 of FIG. 5B may be configured to perform the following tasks: (i) task 550_1 comprising sensory compressing via unsupervised learning; (ii) task 550_2 comprising reward signal prediction by a critic block via supervised learning; and (ii) task 550_3 comprising implementation of optimal action by an actor block via reinforcement learning. The user may specify that task 550_1 may receive external input {X}542, comprising, for example raw audio or video stream, output 546 of the task 550_1 may be routed to each of tasks 550_2, 550_3, output 547 of the task 550_2 may be routed to the task 550_3; and the external signal {r} (544) may be provided to each of tasks 550_2, 5503, via pathways 544_1, 544_2, respectively as illustrated in FIG. 5B. In the implementation illustrated in FIG. 5B, the external signal {r}may be configured as {r}={y^{d}(t), r(t)}, the pathway 5441 may carry the desired output y^{d}(t), while the pathway 544_2 may carry the reinforcement signal r(t).

Once the user specifies the learning type(s) associated with each task (unsupervised, supervised, and reinforcement, respectively) the controller 520_4 of FIG. 5B may automatically configure the respective performance functions, without further user intervention. By way of illustration, performance function Fᵤ of the task 550_1 may be determined based on (i) ‘sparse coding’; and/or (ii) maximization of information. Performance function F_{S} of the task 550_2 may be determined based on minimizing distance between the actual output 547 (prediction pr) d(r, pr) and the external reward signal r 544_1. Performance function Fᵣ of the task 550_3 may be determined based on maximizing the difference F=r−pr. In some implementations, the end user may select performance functions from a predefined set and/or the user may implement a custom task.

At another instance in a different application, illustrated in FIG. 6, the controller 620_4 may be configured to perform a different set of task: (i) the task 650_1, described above with respect to FIG. 5B; and task 652_4, comprising pattern classification via supervised learning. As shown in FIG. 6, the output of task 650_1 may be provided as the input 666 to the task 650_4.

Similarly to the implementation of FIG. 5B, once the user specifies the learning type(s) associated with each task (unsupervised and supervised, respectively) the controller 620_4 of FIG. 6 may automatically configure the respective performance functions, without further user intervention. By way of illustration, the performance function corresponding to the task 650_4 may be configured to minimize distance between the actual task output 668 (e.g., a class {Y} to which a sensory pattern belongs) and human expert supervised signal 664 (the correct class y^{d}).

Generalized learning methodology described herein may enable the learning apparatus 620_4 to implement different adaptive tasks, by, for example, executing different instances of the generalized learning method, individual ones configured in accordance with the particular task (e.g., tasks 550_1, 550_2, 550_3, in FIG. 5B, and 650_4, 650_5 in FIG. 6). The user of the apparatus may not be required to know implementation details of the adaptive controller (e.g., specific performance function selection, and/or gradient determination). Instead, the user may ‘task’ the system in terms of task functions and connectivity.

### Spiking Network Apparatus

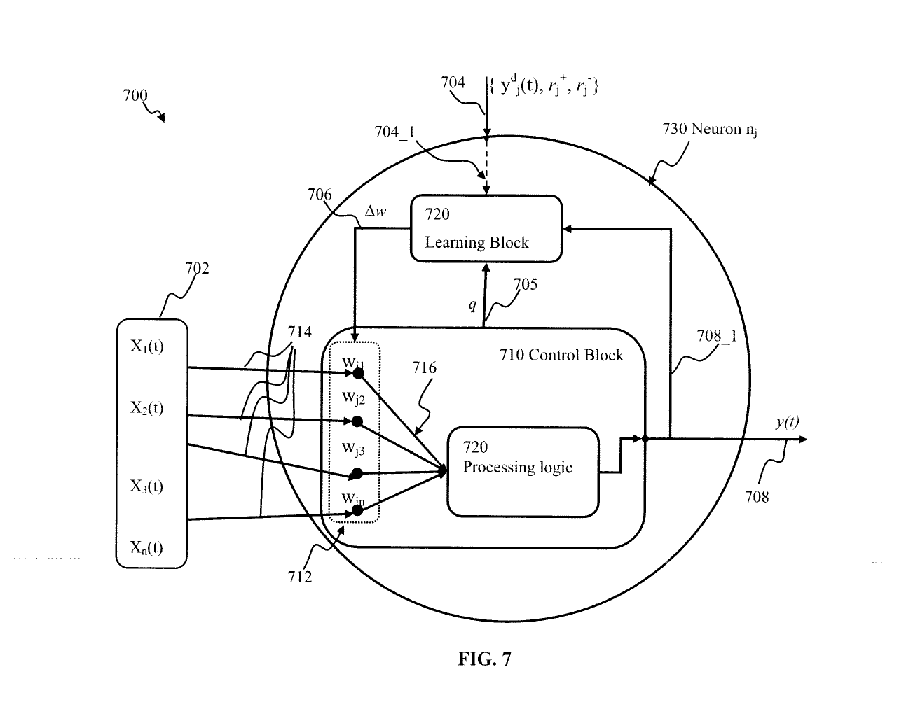

Referring now to FIG. 7, one implementation of spiking network apparatus for effectuating the generalized learning framework of the disclosure is shown and described in detail. The network 700 may comprise at least one stochastic spiking neuron 730, operable according to, for example, a Spike Response Model, and configured to receive n-dimensional input spiking stream X(t) 702 via n-input connections 714. In some implementations, the n-dimensional spike stream may correspond to n-input synaptic connections into the neuron. As shown in FIG. 7, individual input connections may be characterized by a connection parameter 712 wᵢⱼ that is configured to be adjusted during learning. In one or more implementation, the connection parameter may comprise connection efficacy (e.g., weight). In some implementations, the parameter 712 may comprise synaptic delay. In some implementations, the parameter 712 may comprise probabilities of synaptic transmission.

The following signal notation may be used in describing operation of the network 700, below:

$$y ( t ) = {\sum }_{i} δ ( t - {t}_{i} )$$

denotes the output spike pattern, corresponding to the output signal 708 produced by the control block 710 of FIG. 3, where tᵢ denotes the times of the output spikes generated by the neuron;

$${y}^{d} ( t ) = {\sum }_{{t}_{i}} δ ( t - {t}_{i}^{ d} )$$

denotes the teaching spike pattern, corresponding to the desired (or reference) signal that is part of external signal 404 of FIG. 4, where tᵢ^{d} denotes the times when the spikes of the reference signal are received by the neuron;

$${y}^{+} ( t ) = {\sum }_{{t}_{i}} δ ( t - {t}_{i}^{+} ) ; {y}^{-} ( t ) = {\sum }_{{t}_{i}} δ ( t - {t}_{i}^{-} )$$

denotes the reinforcement signal spike stream, corresponding to signal 304 of FIG. 3. and external signal 404 of FIG. 4, where tᵢ⁺, tᵢ⁻ denote the spike times associated with positive and negative reinforcement, respectively.

In some implementations, the neuron 730 may be configured to receive training inputs, comprising the desired output (reference signal) y^{d}(t) via the connection 704. In some implementations, the neuron 730 may be configured to receive positive and negative reinforcement signals via the connection 704.

The neuron 730 may be configured to implement the control block 710 (that performs functionality of the control block 310 of FIG. 3) and the learning block 720 (that performs functionality of the control block 320 of FIG. 3, described supra.) The block 710 may be configured to receive input spike trains X(t), as indicated by solid arrows 716 in FIG. 7, and to generate output spike train y(t) 708 according to a Spike Response Model neuron which voltage v(t) is calculated as:

$$v ( t ) = {\sum }_{i , k} {w}_{i} \cdot α ( t - {t}_{i}^{k} ) ,$$

where wᵢ wᵢ represents weights of the input channels, tᵢ^{k} represents input spike times, and α(t)=(t/τ_{α})e^{1-(t/τ}^{_{α}}⁾ represents an alpha function of postsynaptic response, where τ_{α} represents time constant (e.g., 3 ms and/or other times). A probabilistic part of a neuron may be introduced using the exponential probabilistic threshold. Instantaneous probability of firing λ(t) may be calculated as λ(t)=e^{(v(t)-Th)κ} where Th represents a threshold value, and K represents stochasticity parameter within the control block. State variables S (probability of firing λ(t) for this system) associated with the control model may be provided to the learning block 720 via the pathway 705. The learning block 720 of the neuron 730 may receive the output spike train y(t) via the pathway 708_1. In one or more implementations (e.g., unsupervised or reinforcement learning), the learning block 720 may receive the input spike train (not shown). In one or more implementations (e.g., supervised or reinforcement learning) the learning block 720 may receive the learning signal, indicated by dashed arrow 704_1 in FIG. 7. The learning block determines adjustment of the learning parameters w, in accordance with any methodologies described herein, thereby enabling the neuron 730 to adjust, inter alia, parameters 712 of the connections 714.

In one or more implementations, learning implementation may comprise an addition (or subtraction) of a constant term to the performance function of a spiking neurons, in accordance, for example, with Eqn. 45, that may lead to non-associative potentiation (or depression) of synaptic connections (e.g., the connections 714 in FIG. 7) thereby adjusting neuron excitability and providing additional exploration mechanism In one or more implementations, non-associative potentiation (or depression) may comprise weight changes that do not correspond to a particular performance function.

### Exemplary Methods

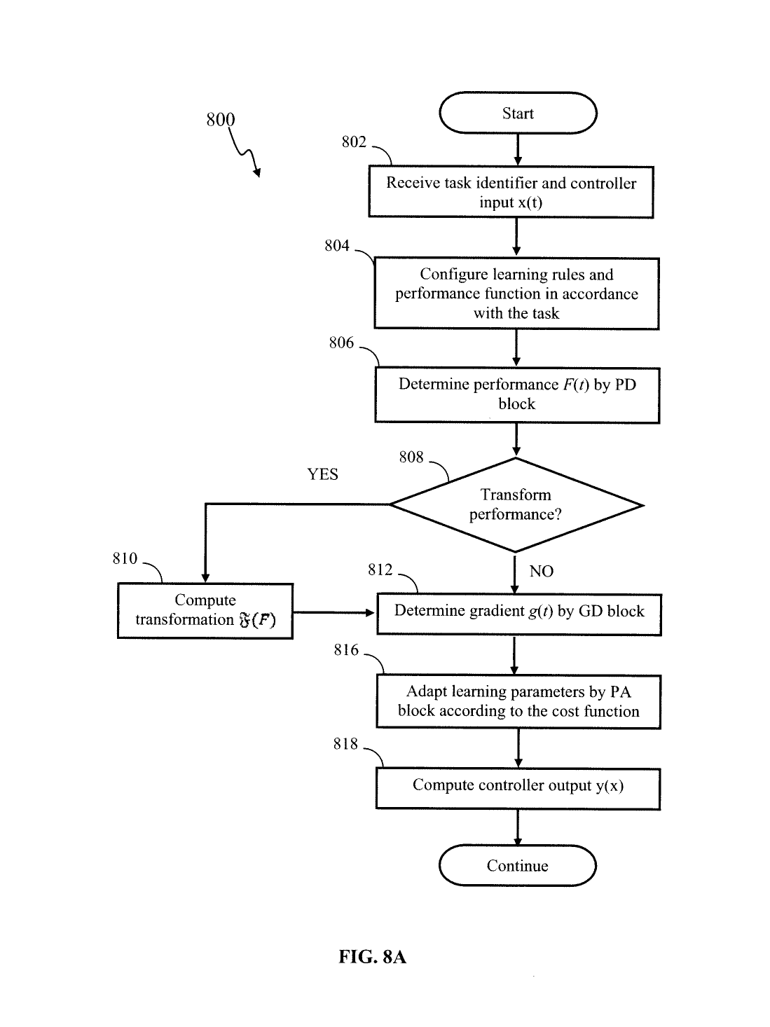

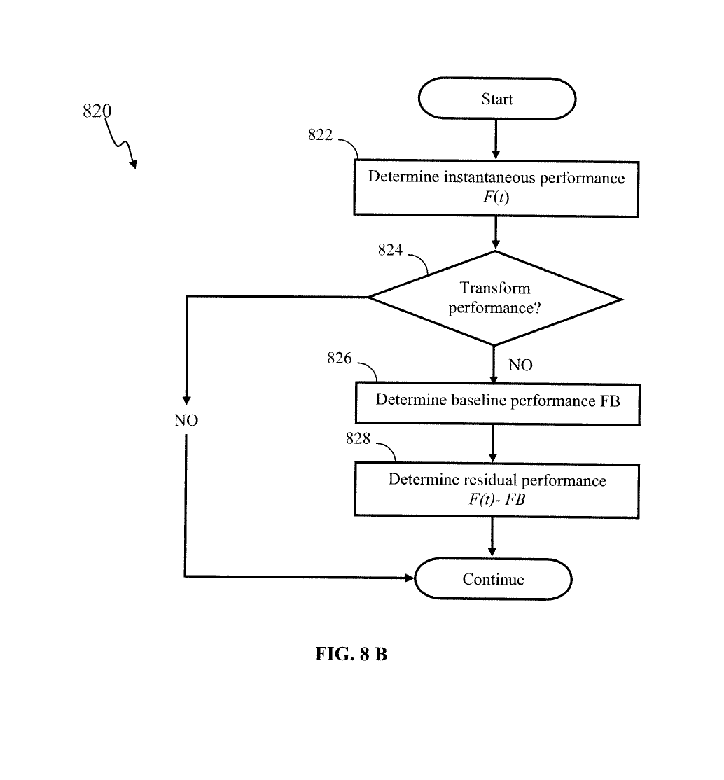

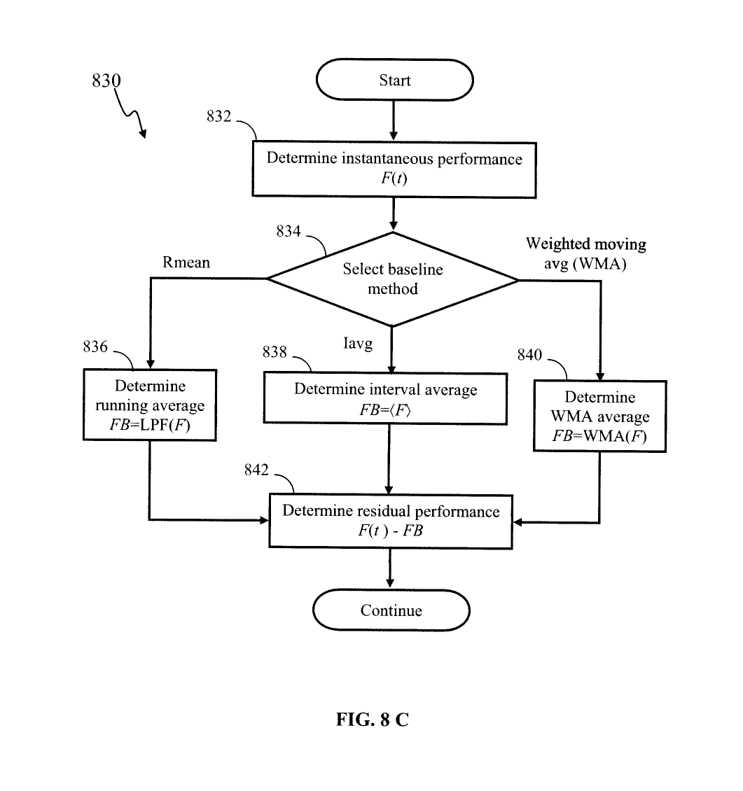

Referring now to FIG. 8A, one exemplary implementation of the generalized learning method of the disclosure for use with, for example, the learning block 420 of FIG. 4, is described in detail. The method 800 of FIG. 8A may allow the learning apparatus to improve learning by, inter alia: (i) reducing convergence time; and (ii) reducing residual performance error. In one or more implementations, these improvements may be effectuated by applying performance transformation as described, for example, with respect to Eqn. 46-Eqn. 48 above.

At step 802 of method 800 the input information may be received. In some implementations (e.g., unsupervised learning) the input information may comprise the input signal x(t), which may comprise raw or processed sensory input, input from the user, and/or input from another part of the adaptive system. In one or more implementations, the input information received at step 802 may comprise learning task identifier configured to indicate the learning rule configuration (e.g., Eqn. 43) that should be implemented by the learning block. In some implementations, the indicator may comprise a software flag transited using a designated field in the control data packet. In some implementations, the indicator may comprise a switch (e.g., effectuated via a software commands, a hardware pin combination, or memory register).

At step 804, learning framework of the performance determination block (e.g., the block 424 of FIG. 4) may be configured in accordance with the task indicator. In one or more implementations, the learning structure may comprise, inter alia, performance function configured according to Eqn. 43. In some implementations, parameters of the control block, e.g., number of neurons in the network, may be configured.

At step 808, the status of the learning indicator may be checked to determine whether performance transformations are to be performed at step 810. In one or more implementations, these transformations may comprise, for example, the manipulations described with respect to Eqn. 46-Eqn. 48 above.

At step 812, the value of the present performance may be computed using the performance function F(x,y,r) configured at the prior step. It will be appreciated by those skilled in the arts, that when performance function is evaluated for the first time (according, for example to Eqn. 35) and the controller output y(t) is not available, a pre-defined initial value of y(t) (e.g., zero) may be used instead.

At step 814, gradient g(t) of the score function (logarithm of the conditional probability of output) may be determined according by the GD block (e.g., The block 422 of FIG. 4) using methodology described, for example, in co-owned and co-pending U.S. patent application Ser. No. 13/______ entitled “STOCHASTIC SPIKING NETWORK APPARATUS AND METHODS”, incorporated supra.

At step 816, learning parameter w update may be determined by the Parameter Adjustment block (e.g., block 426 of FIG. 4) using the performance function F and the gradient g, determined at steps 812, 814, respectively. In some implementations, the learning parameter update may be implemented according to Eqns. 22-31. The learning parameter update may be subsequently provided to the control block (e.g., block 310 of FIG. 3).

At step 818, the control output y(t) of the controller may be updated using the input signal x(t) (received via the pathway 820) and the updated learning parameter Δw.

FIG. 8B illustrates a method of performance transformation comprising base line performance removal, useful, for example, with a learning controller apparatus of FIG. 5 operated according to a learning process configured in accordance with any of the methodologies described herein.

At step 822 of the method 820, instantaneous performance F(t) of the learning process be computed.

At step 824, it is determined whether the performance transformation is to be applied. In some implementations, the determination of the step 824 may comprise an evaluation of a hardware or software flag (e.g., a memory register). In one or more implementations, the performance function may be configured to comprise the transformation and the step 824 may, therefore, be effectuated implicitly.

If the transformation is enabled, the baseline performance FB of the process is determined at step 826. In one or more implementations, the baseline performance may comprise interval average, running average, weighted moving average, and/or other averages.

At step 828, the instantaneous performance, obtained at step 822, is transformed by removing the baseline estimate from the instantaneous performance F(t)-FB.

FIG. 8C illustrates a method of performance transformation comprising base line performance removal of the method of FIG. 8B, where the base line estimate comprises interval average, running mean average, and weighted moving average, in accordance with some implementations.

At step 832 baseline determination method may be established. In some implementations, the determination of the step 824 may comprise an evaluation of a hardware or software flag (e.g., a memory register). In one or more implementations, the performance function may be configured to comprise the appropriate baseline determination process and the step 834 may, therefore, be effectuated implicitly.

When running mean baseline is selected at step 834, the method may proceed to step 838 where the performance baseline may be determined using for example Eqn. 47, in one implementation.

When interval average baseline is selected at step 834, the method may proceed to step 836 where the performance baseline may be determined using for example Eqn. 48, in one implementation.

When moving average mean baseline is selected at step 834, the method may proceed to step 840 where the performance baseline may be determined using any applicable methodologies.

At step 842, the instantaneous performance obtained at step 832 may be transformed by removing the baseline estimate from the instantaneous performance F(t)-FB.

### Performance Results

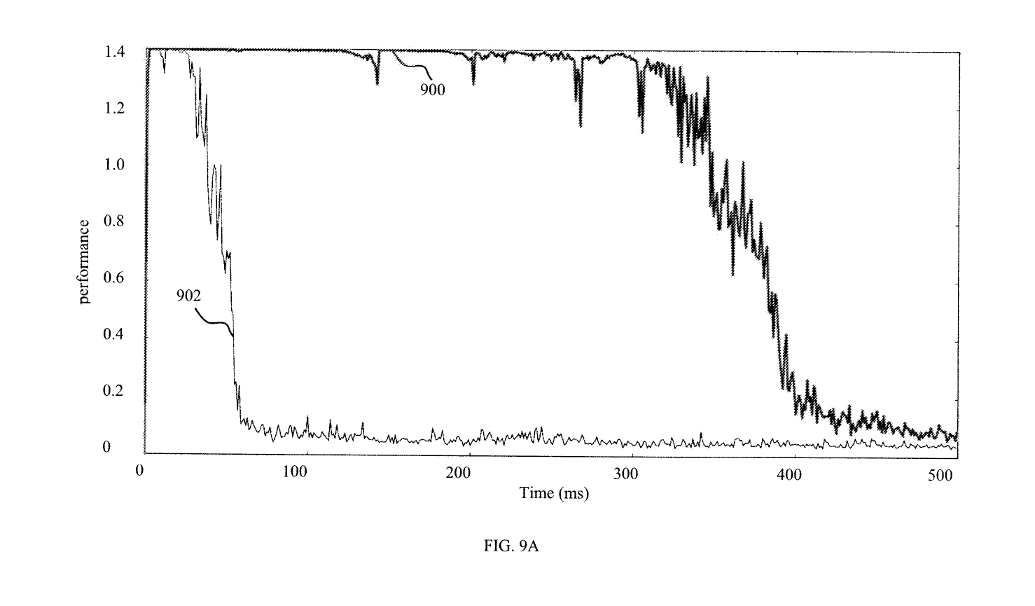

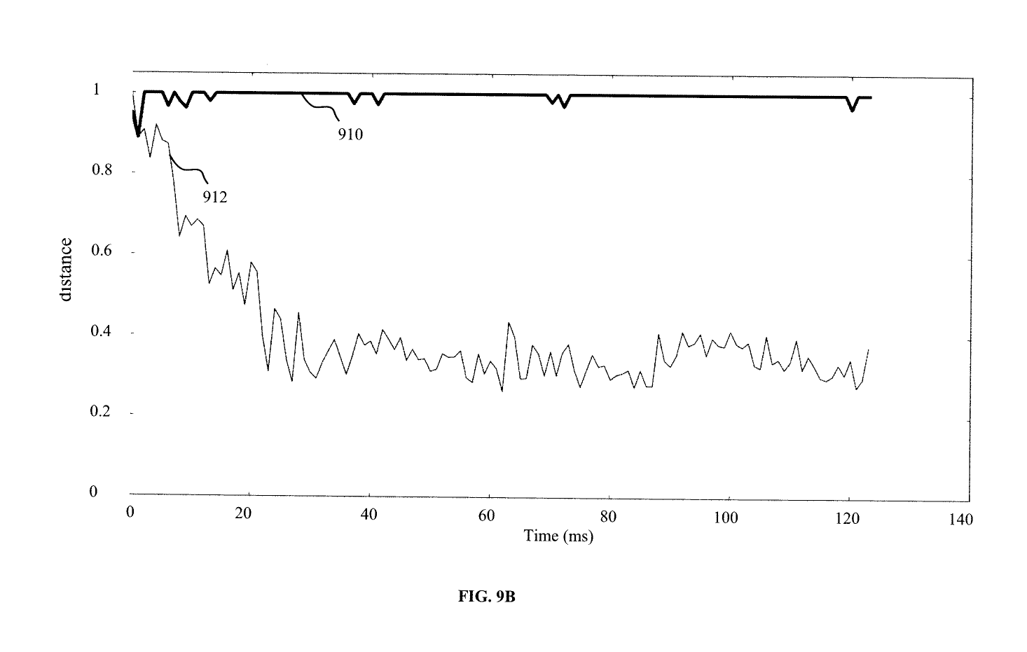

FIGS. 9A and 9B present performance results obtained during simulation and testing by the Assignee hereof, of exemplary computerized spiking network apparatus configured to implement accelerated learning framework comprising performance transformations described above with respect to Eqn. 47. The exemplary apparatus, in one implementation, may comprise learning block (e.g., the block 420 of FIG. 4) that implemented using spiking neuronal network 700, described in detail with respect to FIG. 7, supra.

FIG. 9A illustrates performance of spiking network configured to control an inverted pendulum in an upright orientation using reinforcement learning rule. Reinforcement may be inversely proportional to the absolute value of angle from the vertical orientation (also referred to as the angular distance). The goal of learning in this realization may be to minimize the distance, thereby maximizing the performance. The curve denoted 900 in FIG. 9A depicts the pendulum angular position as a function of time. As the time progresses, the reinforcement learning mechanism may improve network control ability, as illustrated by a sharp decrease in the angular distance after about 300 ms.

The curve 902 in FIG. 9A depicts performance of the same network, which may be configured to compute and remove baseline of the performance. The baseline in this realization may comprise temporal average computed using Eqn. 47. As seen from the results depicted by the curve 902, the transformation of the performance dramatically increases learning speed that enables the network to achieve control of the pendulum after about 60 ms (compared to 400 ms for the curve 900). Furthermore, the residual error of the data shown by the curve 902 is smaller by a factor of about 3-4.

FIG. 9B illustrates performance of spiking network configured to control the pendulum using supervised learning rule. The performance (error signal) may be inversely proportional to the absolute value of angle from the vertical orientation (the desired output). The goal of learning in this realization may be to minimize the distance, thereby maximizing the performance. The curve denoted 910 in FIG. 9B depicts the pendulum angular position as a function of time. As shown by the curve 910 in FIG. 9B, the supervised learning mechanism is unable to control the pendulum ability, as illustrated by a nearly constant error throughout the 125 ms trial.

Contrast the data of Curve 910 with the data of curve 910 in FIG. 9B, which depicts performance of the same network, configured to perform exponential transformation of the performance in accordance with Eqn. 46, in this realization. The transformation normalizes the reward signal so that it may fall within a very broad range, for example, zero to one, in one implementation. As seen from comparing the two results (910, 912), advantageously the network comprising supervised learning and exponential transformation is capable to rapidly learn to control the pendulum within about 30 ms.

### Exemplary Uses and Applications of Certain Aspects of the Invention

Generalized learning framework apparatus and methods of the disclosure may allow for an improved implementation of single adaptive controller apparatus system configured to simultaneously perform a variety of control tasks (e.g., adaptive control, classification, object recognition, prediction, and/or clasterisation). Unlike traditional learning approaches, the generalized learning framework of the present disclosure may enable adaptive controller apparatus, comprising a single spiking neuron, to implement different learning rules, in accordance with the particulars of the control task.

In some implementations, the network may be configured and provided to end users as a “black box”. While existing approaches may require end users to recognize the specific learning rule that is applicable to a particular task (e.g., adaptive control, pattern recognition) and to configure network learning rules accordingly, a learning framework of the disclosure may require users to specify the end task (e.g., adaptive control). Once the task is specified within the framework of the disclosure, the “black-box” learning apparatus of the disclosure may be configured to automatically set up the learning rules that match the task, thereby alleviating the user from deriving learning rules or evaluating and selecting between different learning rules.

Even when existing learning approaches employ neural networks as the computational engine, each learning task is typically performed by a separate network (or network partition) that operate task-specific (e.g., adaptive control, classification, recognition, prediction rules, etc.) set of learning rules (e.g., supervised, unsupervised, reinforcement). Unused portions of each partition (e.g., motor control partition of a robotic device) remain unavailable to other partitions of the network even when the respective functionality of not needed (e.g., the robotic device remains stationary) that may require increased processing resources (e.g., when the stationary robot is performing recognition/classification tasks).

When learning tasks change during system operation (e.g., a robotic apparatus is stationary and attempts to classify objects), generalized learning framework of the disclosure may allow dynamic re-tasking of portions of the network (e.g., the motor control partition) at performing other tasks (e.g., visual pattern recognition, or object classifications tasks). Such functionality may be effected by, inter alia, implementation of generalized learning rules within the network which enable the adaptive controller apparatus to automatically use a new set of learning rules (e.g., supervised learning used in classification), compared to the learning rules used with the motor control task. These advantages may be traded for a reduced network complexity, size and cost for the same processing capacity, or increased network operational throughput for the same network size.

Generalized learning methodology described herein may enable different parts of the same network to implement different adaptive tasks (as described above with respect to FIGS. 5B-6). The end user of the adaptive device may be enabled to partition network into different parts, connect these parts appropriately, and assign cost functions to each task (e.g., selecting them from predefined set of rules or implementing a custom rule). The user may not be required to understand detailed implementation of the adaptive system (e.g., plasticity rules and/or neuronal dynamics) nor is he required to be able to derive the performance function and determine its gradient for each learning task. Instead, the users may be able to operate generalized learning apparatus of the disclosure by assigning task functions and connectivity map to each partition.

Furthermore, the learning framework described herein may enable learning implementation that does not affect normal functionality of the signal processing/control system. By way of illustration, an adaptive system configured in accordance with the present disclosure (e.g., the network 600 of FIG. 6A or 700 of FIG. 7) may be capable of learning the desired task without requiring separate learning stage. In addition, learning may be turned off and on, as appropriate, during system operation without requiring additional intervention into the process of input-output signal transformations executed by signal processing system (e.g., no need to stop the system or change signals flow.

In one or more implementations, the generalized learning apparatus of the disclosure may be implemented as a software library configured to be executed by a computerized neural network apparatus (e.g., containing a digital processor). In some implementations, the generalized learning apparatus may comprise a specialized hardware module (e.g., an embedded processor or controller). In some implementations, the spiking network apparatus may be implemented in a specialized or general purpose integrated circuit (e.g., ASIC, FPGA, and/or PLD). Myriad other implementations may exist that will be recognized by those of ordinary skill given the present disclosure.

Advantageously, the present disclosure can be used to simplify and improve control tasks for a wide assortment of control applications including, without limitation, industrial control, adaptive signal processing, navigation, and robotics. Exemplary implementations of the present disclosure may be useful in a variety of devices including without limitation prosthetic devices (such as artificial limbs), industrial control, autonomous and robotic apparatus, HVAC, and other electromechanical devices requiring accurate stabilization, set-point control, trajectory tracking functionality or other types of control. Examples of such robotic devices may include manufacturing robots (e.g., automotive), military devices, and medical devices (e.g., for surgical robots). Examples of autonomous navigation may include rovers (e.g., for extraterrestrial, underwater, hazardous exploration environment), unmanned air vehicles, underwater vehicles, smart appliances (e.g., ROOMBA®), and/or robotic toys. The present disclosure can advantageously be used in other applications of adaptive signal processing systems (comprising for example, artificial neural networks), including: machine vision, pattern detection and pattern recognition, object classification, signal filtering, data segmentation, data compression, data mining, optimization and scheduling, complex mapping, and/or other applications.

It will be recognized that while certain aspects of the disclosure are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the invention. This description is in no way meant to be limiting, but rather should be taken as illustrative of the general principles of the invention. The scope of the disclosure should be determined with reference to the claims.

What is claimed is:

1. A computer readable apparatus comprising a storage medium, said storage medium comprising a plurality of instructions configured to, when executed, accelerate convergence of a task-specific stochastic learning process towards a target response by at least:
at time determine response of said process to (i) input signal, said response having a present performance associated therewith, said performance configured based at least in part on said response, said input signal and a deterministic control parameter;
determine a time-averaged performance based at least in part on a plurality of past performance values, each of said past performance values having been determined over a time interval prior to said time; and
adjust said control parameter based at least in part on a combination of said present performance and said time-averaged performance;
wherein said combination is configured to effectuate said accelerate convergence characterized by a shorter convergence time compared to parameter adjustment configured based solely on said present performance.

2. The apparatus of claim 1, wherein:
said adjust said control parameter is configured to transition said response to another response, said transition having a performance measure associated therewith;
said response having state of said process associated therewith;
said another response having another state of said process associated therewith;
said target response is characterized by a target state of said process; and
a value of said measure, comprising a difference between said target state and said another state is smaller compared to another value of said measure, comprising a difference between said target state and said state.

3. The apparatus of claim 1, wherein said combination comprises a difference between said present performance and said time-averaged performance.

4. The apparatus of claim 1, wherein:
said response is configured to be updated at a response interval;
said time averaged performance is determined with respect to a time interval, said time interval being greater that said response interval.

5. The apparatus of claim 1, wherein a ratio of said time interval to said response interval is in the range between 2 and 10000.

6. The apparatus of claim 1, wherein:
said control parameter is configured in accordance with said task; and
said adjust said control parameter is configured based at least in part on said input signal and said response.

7. A method of implementing task learning in a computerized stochastic spiking neuron apparatus, the method comprising:
operating said apparatus in accordance with a stochastic learning process characterized by a deterministic learning parameter, said process configured, based at least in part, on an input signal and said task;
configuring performance metric based at least in part on (i) a response of said process to said signal and said learning parameter, and (ii) said input;
applying a monotonic transformation to said performance metric, said monotonic transformation configured to produce transformed performance metric;
determining an adjustment of said learning parameter based at least in part on an average of said transformed performance metric, and
applying said adjustment to said stochastic learning process, said applying is configured to reduce time required to achieve desired response by said apparatus to said signal;
wherein said transformation is configured to accelerate said task learning.

8. The method of claim 7, wherein:
said process is characterized by (i) a present state having present value of the learning parameter and a present value of the performance metric associated therewith; and target state having target value of the learning parameter and a target value of the performance metric associated therewith; and
said learning comprises minimizing said performance metric such that said target value of the performance metric is less than said present value of the performance metric.

9. The method of claim 8, wherein:
said minimizing said performance metric comprises transitioning said present state towards said target state, said transitioning effectuated by at least said applying said adjustment to said stochastic learning process; and
accelerate of said learning is characterized by a convergence time interval that is smaller when compared to parameter adjustment configured based solely on said performance metric.

10. The method of claim 8, wherein said stochastic learning process is characterized by a residual error of said performance metric; and
said applying said transformation is configured to reduce said residual error compared to another residual error associated with said process being operated prior to said applying said transformation.

11. The method of claim 7, wherein said process comprises:
minimization of said performance metric with respect to said learning parameter;
said monotonic transformation comprises an additive transformation comprising a transform parameter; and
said transformed performance metric is free from systematic deviation.

12. The method of claim 11, wherein said transform parameter comprises a constant configured to cause said adjustment of said learning parameter that is not associated with value of said performance metric.

13. The method of claim 7, wherein said transformation is configured to reduce effectuate exploration.

14. The method of claim 7, wherein said process comprises:
minimization of said performance metric with respect to said learning parameter;
said monotonic transformation comprises an exponential transformation comprising an exponent parameter and an offset parameter; and
said transformed performance metric is free from systematic deviation.

15. A computerized spiking network apparatus comprising one or more processors configured to execute one or more computer program modules, wherein execution of individual ones of the one or more computer program modules causes the one or more processors to reduce convergence time of a process effectuated by said network by at least:
operate said process according to a hybrid learning rule configured to generate an output signal based on an input spike train and a teaching signal;
transform a performance measure associated with said process to obtain a transformed performance measure;
generate an adjustment signal based at least in part on said transformed performance measure; and
wherein applying said adjustment signal to said process is configured to achieve said desired output in a shorter period of time compared to applying one other adjustment signal, generate based at least in part on said performance.

16. The apparatus of claim 15, wherein said hybrid learning rule comprising a combination of reinforcement, supervised and unsupervised learning rules effectuated simultaneous with one another.

17. The apparatus of claim 15, wherein said hybrid learning rule is configured to simultaneously effect reinforcement learning rule and unsupervised learning rule.

18. The apparatus of claim 15, wherein:
said teaching signal r comprises a reinforcement spike train determined based at least in part on a comparison between present output, associated with said transformed performance, and said output signal; and
said transformed performance measure is configured to effect a reinforcement learning rule, based at least in part on said reinforcement spike train.

19. The apparatus of claim 18, wherein:
wherein applying said adjustment signal to said process comprises modifying a control parameter associated with said process;
said transformed performance is based at least in part on adjustment of said control parameter from a prior state to present state;
said reinforcement is positive when said present output is closer to said output signal; and
said reinforcement is negative when said present output is farther from said output signal.

20. The apparatus of claim 15, wherein:
said adjustment signal is configured to modify a learning parameter w, associated with said process;
said adjustment signal is determined based at least in part on a product of said transformed performance with a gradient of per-stimulus entropy parameter h, said gradient is determined with respect to said learning parameter; and
said per-stimulus entropy parameter is configured to characterize dependence of said signal on (i) said input signal; and (ii) said learning parameter.

21. The apparatus of claim 20, wherein said per-stimulus entropy parameter h is determined based on a natural logarithm of p(y|x,w), where p denotes conditional probability of said output signal given said input signal x with respect to said learning parameter w.
